(19) United States
(12) Patent Application Publication
(10) Pub. No.: US 2025/0162712 A1
(43) Pub. Date: May 22, 2025

(54) System and Method for Decreasing Hypoxia and Asynchronous Breathing and Improving the Conservation of Gases in Breathing Gas Delivery Systems

(71) Applicant: OXFO Corporation, Chestnut Hill, MA (US)

(72) Inventors: Carlos Fernando Bazoberry, Chestnut Hill, MA (US); Brent H. Young, Boston, MA (US)

(21) Appl. No.: 18/811,648

(22) Filed: Aug. 21, 2024

Related U.S. Application Data
(60) Provisional application No. 63/533,704, filed on Aug. 21, 2023.

(51) Int. Cl. B64D 10/00

(52) U.S. Cl. CPC B64D 10/00

(57) ABSTRACT

A breathing gas supply system, potentially for combat aircraft, operative to decrease hypoxia and asynchronous breathing and to conserve breathing gases. An input valve selectively permits breathing gas to fill a flexible gas reservoir through a fluidic connector. Breathing gas can be maintained at an elevated pressure. The fluidic connector delivers gas to an output interface, such as an oxygen mask. An inspiratory valve is permitted to open when inspiration is sensed by an inspiratory sensor, and an expiratory valve is permitted to open when expiration is sensed by an expiratory sensor. The inspiratory and expiratory sensors can be separate or embodied as an inspiratory-expiratory sensor. A sensor reservoir fluidically open to a volume between the output interface and the face of the user can expand or compress to indicate inspiration or expiration. The inspiratory and expiratory valves can be electromagnetically operated.

### RELATED APPLICATION

This application claims priority to U.S. Provisional Application No. 63/533,704, filed Aug. 21, 2023, which is incorporated herein by reference.

### FIELD OF THE INVENTION

The present invention relates generally to the delivery of breathing gases from a source to a recipient. More particularly, disclosed herein are a system and method for decreasing hypoxia and asynchronous breathing and for improving the conservation of gases in breathing gas delivery systems.

### BACKGROUND OF THE INVENTION

When flying at high altitudes, pilots of high-performance combat aircraft must rely on pressurized, demand-flow respiration masks designed to provide a supply of oxygen adequate to maintain the required oxygen concentration in the pilot's bloodstream. Through such masks, pilots receive a pressurized mixture of air and oxygen to permit breathing in conditions where atmospheric pressure is low and oxygen is insufficient to permit normal respiration. A breathing regulator maintains a supply pressure that is dependent on altitude. Supply pressure may be increased in an alteration referred to as Pressure Breathing for Altitude (PBA). Breathing regulators may also increase supply pressure for g-load, which is referred to as Pressure Breathing for G's (PBG). Under present systems, components must be well-matched to the pilot's needs. However, doing so is complicated by the wide ranges of pilot characteristics as to volume, elasticity, flow resistance, and other characteristics.

There are two main types of breathing support systems used in combat aircraft. Each relies on a pressure demand-flow breathing regulator that receives high-pressure air from a source and that delivers regulated, low-pressure air to the respiration mask through an inhalation check valve to supply inhalation breaths. Each breath must subsequently be exhaled through an exhalation check valve. The inhalation check valve is a relatively complex valve structure typically formed with two spring-loaded flapper elements with portions thereof acting as return springs. To draw a breath, a pilot must exert an inhalation force to create a differential pressure sufficient to overcome the return spring force thereby opening the flappers. The exhalation check valve is a complex assembly of mechanical components. It includes a compressible bladder designed to allow the exhalation valve to operate at a similar pressure as the inhalation valve. Under such constructions, the pilot must exert an exhalation force to open the valve and to allow a breath to be exhausted.

To open, inhalation check valves typically require a negative alveolar pressure, which must be induced by contraction of the diaphragm and intercostal muscles, in excess of −4 cm/H₂O. This increases the work of breathing. Once the valve is opened by that negative alveolar pressure, gas is delivered at a high flow designed to overcompensate for any higher peak flows the pilot may require to avoid running out of oxygen flow during inspiration. To close the inhalation check valve, the pilot must use his or her abdominal muscles to expire forcefully to create pressure in excess of 4 cm/H₂O. Added positive pressure must be exerted to open the expiratory valve to collapse the bladder of the exhalation check valve.

Due to the forces necessary to actuate the inhalation and exhalation valves, breathing using such systems is not a natural act nor is it necessarily comfortable. It must be learned and practiced. As pilots encounter higher altitudes and forces during flight, their breathing often becomes more irregular and disorganized. This is particularly true during chaotic and stressful events.

Thus, despite the existence of advanced breathing systems, modern fighter jet pilots face significant problems with obtaining a reliable supply of oxygen at high altitudes. Pilots often suffer dangerous health effects and discomfort from inadequate oxygen supply. For instance, where the bloodstream, tissue, and the brain are inadequately supplied with oxygen, hypoxia rapidly sets in. If unchecked, hypoxia leads to confusion and, ultimately, loss of consciousness. For pilots in particular, hypoxia can lead to deadly consequences. Pilots can also experience asynchronous breathing or Breathing Sequence Disruption (BSD) where the demand for inhalation does not match the supply provided by the system. Such asynchronous breathing can lead to discomfort, panic, and other negative effects.

Problems with providing reliable oxygen supply to pilots during high altitude flight are so pronounced that NASA recently commissioned a Pilot Breathing Assessment (PBA) program designed to study and analyze the supply of oxygen to pilots in high-performance fighter jets. Researchers found that certain fighter jet breathing systems delivered an unpredictable amount of air flow at the beginning, middle, and end of each breath and that the supply of air varied from breath-to-breath. Each of these circumstances is potentially dangerous and uncomfortable to the pilot. Numerous physiological episodes, defined by the United States Air Force as “any anomaly in the interaction among the aircrew, equipment, and environment that causes adverse physical or cognitive symptoms,” have been recorded in relation to modern systems for supplying pressurized air to pilots. According to one NASA report, “At times, the pilot would demand oxygen and got nothing, and at times they received too much.” Physiological episodes in pilots can result in cognitive impairment, numbness, tingling, lightheadedness, behavioral changes, and fatigue, each potentially life-threatening for pilots.

The NASA report included recommendations for users and manufacturers of the aircraft systems, including using the results to create future hardware to meet pilot physiological needs. However, it has been opined by Jack Stewart, a former naval aviator, that there is “no real solution in the works, and little hope of one anytime soon.” Rather than an effective solution in breathing systems, the best solution at the moment, again according to Jack Stewart, is “relying on pilot training, which includes subjecting them to hypobaric chamber which simulates the reduced pressure” with the goal of having “pilots recognize how the world looks and feels when they're not getting enough oxygen, then react accordingly.” Thus, rather than addressing the actual problems exhibited by prior art breathing systems, the best known solution has been to train pilots on how better to handle the dangerous and uncomfortable difficulties presented.

Notably, there is a similarity in the etiology between hypoxia and asynchronous breathing as experienced by medical patients and fighter pilots, and the prior art is similarly devoid of effective and elegant solutions. For instance, attempts to provide consistent triggering of the adequate supply of inhalation breaths have been imperfect at best. For instance, certain current triggering techniques can exhibit ineffective triggering thereby preventing adequate supply while other systems can exhibit auto-triggering such that the ventilator triggers a breath when it improperly recognizes a flow or pressure variation in the circuit as being spontaneous respiratory muscular effort by the patient. Leaks with depressurization of the circuit or flow, pressure oscillations due to the presence of condensate in the circuit, and the transmission of intrathoracic pressure variations can trick the system leading to discomfort and potential jeopardy.

Mechanical ventilation (MV) devices can be used to treat respiratory failure deriving from plural different sources. MV devices, which have been dramatically improved over the past century, can provide invasive ventilation in intubated patients and non-invasive ventilation (NIV) in patients who are not intubated. NIV encompasses several methods of respiratory support, the most common being Bi-level Positive Airway Pressure (BPAP) and Continuous Positive Airway Pressure (CPAP) for obstructive sleep apnea (OSA). Such systems seek to provide balances between patient inspiratory effort and triggering, between demand and flow and tidal volume, and between patient inspiration interruptions and system cycling.

For such mechanical ventilators, interaction between the patient and the ventilator is required to be effective for spontaneous breathing patients. The machine seeks to deliver a breath and then to allow the patient to breathe out naturally. Each part of the respiratory cycle should be synchronous with the machine's cycle. Otherwise, patient-ventilator asynchrony (PVA) will occur with detrimental effects to the patient. According to the 2018 work entitled Patient-ventilator asynchrony by Holanda M A, Vasconcelos Rd S, Ferreira J C, Pinheiro B V; J Bras Pneumol 2018; 44(4): 321-33. doi: 10.1590/S1806-375644-04-00321, such consequences include “discomfort, dyspnea, worsening of pulmonary gas exchange, increased work of breathing, diaphragmatic injury, sleep impairment, and increased use of sedation or neuromuscular blockade, as well as increases in the duration of MV, weaning time, and mortality.”

For non-invasive ventilators to have improved effectiveness, primarily by decreasing patient-ventilator asynchrony and secondarily by providing a stable concentration of oxygen, by conserving gases, and by improving ventilation, it is crucial in such systems to have reliable and real-time monitoring of patient respiratory parameters during therapy. This adds a substantial layer of complexity in structure and operation and introduces inherent reliance on pressure and flow sensors, lack of leakage, and complex mathematical algorithms, which are by their nature approximations that increase the chance of asynchronous breathing.

In trying to achieve their goals, non-invasive ventilators unfortunately require the delivery of overcompensated, high flows seeking to ensure that the patient's peak inspiratory flow rate does not exceed that of the regulator. Where that requirement is not met, the patient may be unable to fill his or her lungs at the end of inspiration, and this can cause one of two consequences. One is that a vacuum is created in the patient interface before the end of the inspiration. Another is that, if the mask or other patient interface allows it, entrained air may leak in thereby undesirably decreasing the inspired concentration of oxygen and potentially creating hypoxic events.

Disadvantageously, such overcompensating, high flows intentionally leak gas from the system. This introduces its own disadvantages, including the need to calculate and maintain the required intentional leakage and costly waste for patients and institutions. Indeed, only a small portion of the large gas flow is actually used while the majority is wasted to the environment. Such systems also exhibit increased noise caused by the needed high flow rates. Still further, they require increased energy use where air or oxygen must be compressed, and they present an increased need for consumables to heat and humidify such high flows.

It is thus apparent that there is a real and substantial need, a need expressly recognized by experts in the field and the United States government, for a system and method for supplying breathing gases smoothly, comfortably, and in adequate volume thereby to decrease hypoxia and asynchronous breathing.

### SUMMARY OF THE INVENTION

The present invention is thus founded on the basic object of providing a system for the delivery of breathing gas that decreases or eliminates the risks of hypoxia, asynchronous breathing, and other physiological episodes during gas delivery.

A related object of the invention is to provide a system for breathing gas delivery that reliably supplies breathing gas to a recipient in a volume adequate to accommodate peak inspiratory flow rates.

A further object of the invention is to provide a system for breathing gas delivery that adapts to varied breathing characteristics, including breathing volume, lung elasticity, flow resistance, and other characteristics, while avoiding variability with respect to the fraction of inspired oxygen (FiO2) provided to the recipient.

Another object of embodiments of the invention is to provide a system and method for delivering breathing gases in a natural and comfortable breathing pattern without a substantial increase in the work in breathing.

A related object of embodiments of the invention is to provide a system and method for delivering breathing gases in which a user need not exert excessive inhalation or exhalation forces simply to initiate the process of inhalation or exhalation.

A further object of embodiments of the invention is to provide a system and method for delivering breathing gases effectively, consistently, and comfortably even during chaotic and stressful events.

Yet another object of embodiments of the invention is to provide a system and method for delivering breathing gases that reduces losses in oxygen and other breathing gases.

These and further objects, advantages, and details of the present invention will become obvious not only to one who reviews the present specification and drawings but also to those who have an opportunity to experience the systems and methods disclosed herein in operation. However, it will be appreciated that, although the accomplishment of plural of the foregoing objects in a single embodiment of the invention may be possible and indeed preferred, not all embodiments will seek or need to accomplish each and every potential advantage and function. Nonetheless, all such embodiments should be considered within the scope of the present invention.

In carrying forth one or more objects of the invention, one embodiment of the invention can be characterized as a supply system for decreasing hypoxia and asynchronous breathing and for improving the conservation of breathing gases in breathing gas delivery through a mechanical ventilation system. The supply system may be considered to be founded on an expandable and compressible gas reservoir. The gas reservoir has an outer wall and an inner volume for retaining a volume of breathing gas. A fluidic connector is sealingly engaged with the gas reservoir, and an input valve is in fluidic communication with the gas reservoir through the fluidic connector. The input valve is disposed fluidically upstream of the gas reservoir for receiving pressurized breathing gas from one or more pressurized gas sources and for selectively permitting breathing gas to flow to and fill the gas reservoir through the fluidic connector. The fluidic connector is operative to deliver breathing gas received from the input valve into the inner volume of the gas reservoir, and the fluidic connector is operative to deliver gas out of the inner volume of the gas reservoir. An output interface, such as a respiratory mask, outputs breathing gas to a face of a user, and a supply conduit is fluidically interposed between the gas reservoir and the output interface. In inspiratory sensor in fluidic communication with the output interface is operative to sense inspiration through the output interface, and an expiratory sensor in fluidic communication with the output interface is operative to sense expiration through the output interface. It is possible to have separate inspiratory and expiratory sensors or for a single sensor to be operative as both an inspiratory and expiratory sensor. An inspiratory valve is fluidically interposed between an inner volume of the output interface and the gas reservoir, and an expiratory valve is in fluidic communication with the output interface. The supply system is operative to permit an opening of the inspiratory valve when inspiration is sensed by the inspiratory sensor, and the supply system is operative to permit an opening of the expiratory valve when expiration is sensed by the expiratory sensor.

In practices of the invention, the gas reservoir is housed within a rigid reservoir housing. In such embodiments, a distance sensor can be retained by the housing to be operative to sense a distance of the outer wall of the gas reservoir from the distance sensor. The input valve can then be operative to open and close to permit or prevent flow of breathing gas to the reservoir based on the distance of the outer wall of the gas reservoir from the distance sensor as sensed by the distance sensor.

In certain manifestations of the supply system, the output interface comprises a respiration mask such that a mask inner volume is established between the respiration mask and the face of the user. In those embodiments, the expiratory valve can be retained by the respiration mask.

As taught herein, the inspiratory sensor can take the form of a sensor reservoir positioned to be fluidically open to an output interface inner volume between the output interface and the face of the user. The inspiratory sensor is operative to detect a state of inflation of the sensor reservoir with a predetermined pressure differential between the output interface inner volume interior and a volume exterior to the output interface operating to expand or compress the sensor reservoir to indicate that the user is inhaling and with the sensor reservoir compressing or expanding when the user ceases inhaling and begins exhaling. The supply system is then operative to close or permit an opening of the inspiratory valve based on the state of inflation of the sensor reservoir.

In a similar manner, the expiratory sensor can comprise a sensor reservoir positioned to be fluidically open to an output interface inner volume between the output interface and the face of the user with the expiratory sensor being operative to detect a state of inflation of the sensor reservoir. A predetermined pressure differential between the output interface inner volume interior and a volume exterior to the output interface will then expand or compress the sensor reservoir to indicate that the user is inhaling, and the sensor reservoir will tend to compress or expand when the user ceases inhaling and begins exhaling. The supply system can then be operative to close or permit an opening of the expiratory valve based on the state of inflation of the sensor reservoir. Again, it is within the scope of the invention for an inspiratory-expiratory sensor to be operative both as the inspiratory sensor and the expiratory sensor.

In particular embodiments, the inspiratory valve comprises an electromagnetic valve with an open condition and a closed condition. The inspiratory valve is actuated to a closed condition when expiration is sensed by the expiratory sensor, and the inspiratory valve is released from the closed condition when inspiration is sensed by the inspiratory sensor. In one such example, the inspiratory valve has a valve leaflet with an open condition and a closed condition and an electromagnetic member operative when actuated to tend to retain the valve leaflet in either the open condition or the closed condition.

The expiratory valve can be similarly constructed to comprise an electromagnetic valve with an open condition and a closed condition. The expiratory valve is actuated to a closed condition when inspiration is sensed by the inspiratory sensor, and the expiratory valve is released from the closed condition when expiration is sensed by the expiratory sensor. As with the inspiratory valve, the expiratory valve can have a valve leaflet with an open condition and a closed condition and an electromagnetic member operative when actuated to tend to retain the valve leaflet in either the open condition or the closed condition.

The supply system can incorporate a pressure sensor operative to detect a pressure of the breathing gas within the inner volume of the reservoir with the input valve and the pressure sensor cooperating to maintain breathing gas within the gas reservoir at an elevated pressure above ambient pressure, such as approximately 4 cm/H₂O. In non-limiting examples of the invention, the gas reservoir can have an inner volume of approximately 2.5 liters.

As disclosed herein, the outer wall of the gas reservoir can be formed from a polymeric film. By way of presently preferred example, the polymeric film can comprise a film of biaxially oriented polyethylene terephthalate (BOPET). The film can be metalized, such as through a coating with aluminum.

In practices of the system, the fluidic connector can comprise a multi-port fluidic connector. The connector can, for instance, have an input port for receiving breathing gas and an output port for supplying breathing gas to the output interface. The fluidic connector further has a connection port, and a pressure sensor fluidically connected to the connection port is operative to detect a pressure of breathing gas within the inner volume of the reservoir.

It is also taught herein for at least one of a sensing of inspiration by the inspiratory sensor and a sensing of expiration by the expiratory sensor to be operative to trigger an opening or a closing of the input valve. For instance, practices of the system can automatically open the input valve to supply breathing gas to the gas reservoir on a detection of inspiration by the inspiratory sensor. Additionally or alternatively, the input valve can be automatically opened or closed based on a detection of expiration by the expiratory sensor.

Also according to embodiments of the invention, the inspiratory valve can comprise an electromagnetic valve with an open condition and a closed condition, and the inspiratory valve can be actuated to the closed condition when expiration is sensed by the expiratory sensor. The inspiratory valve can be released from the closed condition when inspiration is sensed by the inspiratory sensor. The inspiratory valve can have a valve leaflet that is pivotable between an open orientation where gas is allowed to flow through the valve and a closed orientation where gas is prevented from flowing through the valve. The valve leaflet is selectively maintained in the closed condition by electromagnetic force when expiration is sensed by the inspiratory sensor. Similarly, the expiratory valve can comprise an electromagnetic valve with an open condition and a closed condition that is actuated to the closed condition when inspiration is sensed by the inspiratory sensor. The expiratory valve can be released from the closed condition when expiration is sensed by the expiratory sensor. As with the inspiratory valve, the expiratory valve can have a valve leaflet that is pivotable between an open orientation where gas is allowed to flow through the valve and a closed orientation where gas is prevented from flowing through the valve, and the valve leaflet can be selectively maintained in the closed condition by electromagnetic force when inspiration is sensed by the inspiratory sensor.

Particular manifestations of the invention can be characterized as a combat aircraft oxygen supply system in a combat aircraft. The system is constructed to decrease hypoxia and asynchronous breathing in combat aircraft pilots and to improve the conservation of oxygen in oxygen delivery through an aircraft mechanical ventilation system. Such a combat aircraft supply system relies on an expandable and compressible oxygen reservoir with an outer wall and an inner volume for retaining a volume of oxygen. An input valve is in fluidic communication with the oxygen reservoir and is disposed fluidically upstream of the oxygen reservoir for receiving pressurized oxygen from one or more pressurized oxygen sources and for selectively permitting oxygen to flow to and fill the oxygen reservoir. An oxygen mask is provided for outputting oxygen to a combat aircraft pilot wearing the oxygen mask with a mask inner volume being established between the oxygen mask and the face of the combat aircraft pilot. A supply conduit is fluidically interposed between the gas reservoir and the oxygen mask. An inspiratory sensor is in fluidic communication with the oxygen mask and is operative to sense inspiration through the oxygen mask, and an expiratory sensor operative to sense expiration through the oxygen mask is likewise in fluidic communication with the oxygen mask. An inspiratory valve is fluidically interposed between the mask inner volume and the gas reservoir, and an expiratory valve is in fluidic communication with the oxygen mask. The combat aircraft supply system is operative to permit an opening of the inspiratory valve when inspiration is sensed by the inspiratory sensor, and the combat aircraft supply system is operative to permit an opening of the expiratory valve when expiration is sensed by the expiratory sensor.

In embodiments of the combat aircraft supply system, the oxygen reservoir is housed within a rigid reservoir housing, and a distance sensor retained by the housing is operative to sense a distance of the outer wall of the oxygen reservoir from the distance sensor. The input valve is operative to open and close to permit or prevent flow of oxygen to the oxygen reservoir based on the distance of the outer wall of the oxygen reservoir from the distance sensor as sensed by the distance sensor.

The inspiratory sensor can comprise a sensor reservoir positioned to be fluidically open to the mask inner volume with the inspiratory sensor being operative to detect a state of inflation of the sensor reservoir. A predetermined pressure differential between the mask inner volume interior and a volume exterior to the output interface will expand or compress the sensor reservoir to indicate that the combat aircraft pilot is inhaling. The sensor reservoir will compress or expand when the combat aircraft pilot ceases inhaling and begins exhaling. The combat aircraft supply system is operative to close or permit an opening of the inspiratory valve based on the state of inflation of the sensor reservoir. The expiratory sensor can, but need not necessarily be, similarly constructed. The expiratory and inspiratory sensors can be separate, or an inspiratory-expiratory sensor can be operative as the inspiratory sensor and the expiratory sensor.

In embodiments of the combat aircraft supply system, the inspiratory valve comprises an electromagnetic valve with an open condition and a closed condition. The inspiratory valve is actuated to a closed condition when expiration is sensed by the expiratory sensor, and the inspiratory valve is released from the closed condition when inspiration is sensed by the inspiratory sensor.

A pressure sensor can be operative to detect a pressure of the oxygen within the inner volume of the oxygen reservoir, and the input valve and the pressure sensor can cooperate to maintain oxygen within the oxygen reservoir at an elevated pressure above ambient pressure, such as approximately 4 cm/H₂O.

As taught herein, the inspiratory valve of the combat aircraft oxygen supply system can comprise an electromagnetic valve with an open condition and a closed condition. The inspiratory valve is actuated to the closed condition when expiration is sensed by the expiratory sensor, and the inspiratory valve is released from the closed condition when inspiration is sensed by the inspiratory sensor. The inspiratory valve has a valve leaflet that is pivotable between an open orientation where gas is allowed to flow through the valve and a closed orientation where gas is prevented from flowing through the valve, and the valve leaflet is selectively maintained in the closed condition by electromagnetic force when expiration is senses by the inspiratory sensor. In a similar manner, the expiratory valve can comprise an electromagnetic valve with an open condition and a closed condition. The expiratory valve can be actuated to the closed condition when inspiration is sensed by the inspiratory sensor, and the the expiratory valve can be released from the closed condition when expiration is sensed by the expiratory sensor. The expiratory valve has a valve leaflet that is pivotable between an open orientation where gas is allowed to flow through the valve and a closed orientation where gas is prevented from flowing through the valve, and the valve leaflet is selectively maintained in the closed condition by electromagnetic force when inspiration is sensed by the inspiratory sensor.

One will appreciate that the foregoing discussion broadly outlines the more important goals and features of the invention to enable a better understanding of the detailed description that follows and to instill a better appreciation of the inventors' contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

In the accompanying drawing figures:

FIG. 1 is a partially-sectioned view in front elevation of an embodiment of the system for decreasing hypoxia and asynchronous breathing and for improving the conservation of gases in breathing gas delivery systems during inhalation;

FIG. 2 is a partially-sectioned view in front elevation of an embodiment of the system for decreasing hypoxia and asynchronous breathing and for improving the conservation of gases in breathing gas delivery systems disclosed herein during exhalation;

FIG. 3 is an exploded, partially-sectioned view of the reservoir assembly for the system disclosed herein;

FIG. 4 is an assembled, partially-sectioned view of the reservoir assembly for a system according to the present invention;

FIGS. 5A and 5B respectively comprise sectioned plan and side elevation views of an inspiratory/expiratory sensor switch according to the present invention in inflated and deflated switching conditions;

FIGS. 6A through 6H comprise cross-sectioned elevational views of a titratable opening pressure valve disposed along the gas supply conduit, the valve operable based on electro-magnetic forces with an actuator in various states of assembly and actuation;

FIGS. 7A through 7C comprise cross-sectional views in side elevation, front elevation, and in exploded form of a titratable opening pressure valve disposed along the gas supply conduit operable based on electro-magnetic forces on an actuator;

FIG. 8 is a perspective view of a reservoir assembly and connector according to an embodiment of the invention;

FIG. 9 is an alternative perspective view of the reservoir assembly and connector;

FIG. 10 is a lower perspective view of the reservoir assembly and connector;

FIG. 11 is an upper perspective view of the reservoir assembly and connector;

FIG. 12 is a top plan view of the reservoir assembly and connector;

FIG. 13 is a view in side elevation of the reservoir assembly and connector;

FIG. 14 is a view in front elevation of the reservoir assembly and connector;

FIG. 15 is a longitudinally cross-sectioned perspective view of the reservoir assembly and connector as disposed within a casing;

FIG. 16 is a laterally cross-sectioned perspective view of the reservoir assembly;

FIGS. 17A and 17B are partially-exploded and assembled views in front elevation of a respiratory mask with electromagnetic inspiratory and expiratory valves actuated by inspiratory/expiratory sensor switches according to practices of the present invention;

FIGS. 18A through 18D are partially-exploded and assembled cross-sectional views of an inspiratory/expiratory sensor switch according to the present invention; and

FIGS. 19A and 19B comprise sectioned views in side elevation of an electromagnetic valve as disclosed herein in open and closed conditions respectively;

FIGS. 19C and 19D comprise side elevation and top plan views respectively of the electromagnetic valve;

FIG. 19E comprises a sectioned view in front elevation of the electromagnetic valve;

FIGS. 19F and 19G comprise front and side elevation views respectively of the electromagnetic frame of the electromagnetic valve;

FIG. 20 is a perspective view of an alternative reservoir assembly and connector according to an embodiment of the invention; and

FIG. 21 is an alternate perspective view of the reservoir assembly and connector of FIG. 20.

### DETAILED DESCRIPTION OF PREFERRED EMBODIMENTS

The system and method for decreasing hypoxia and asynchronous breathing and for improving the conservation of gases in breathing gas delivery systems disclosed herein are subject to a wide variety of embodiments. However, to ensure that one skilled in the art will be able to understand and, in appropriate cases, practice the system and method disclosed herein, certain preferred embodiments of the broader invention are described below and shown in the accompanying drawing figures.

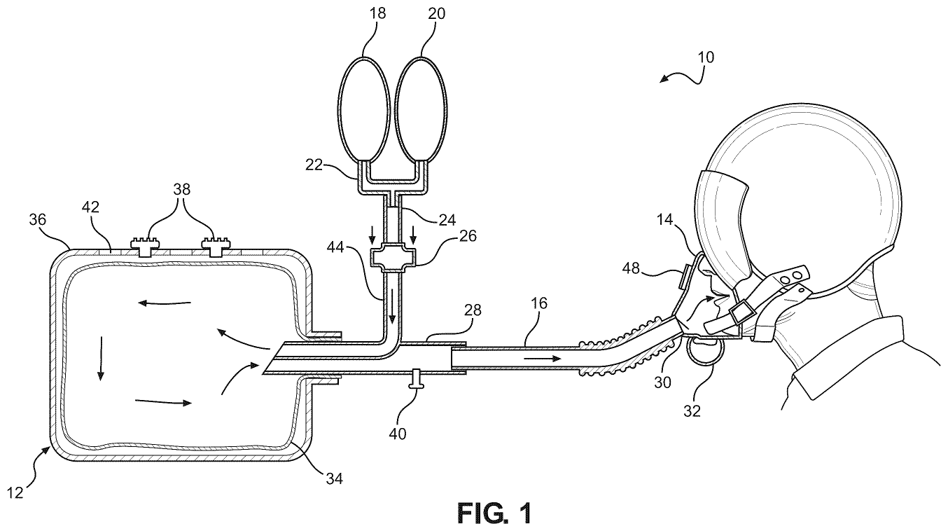

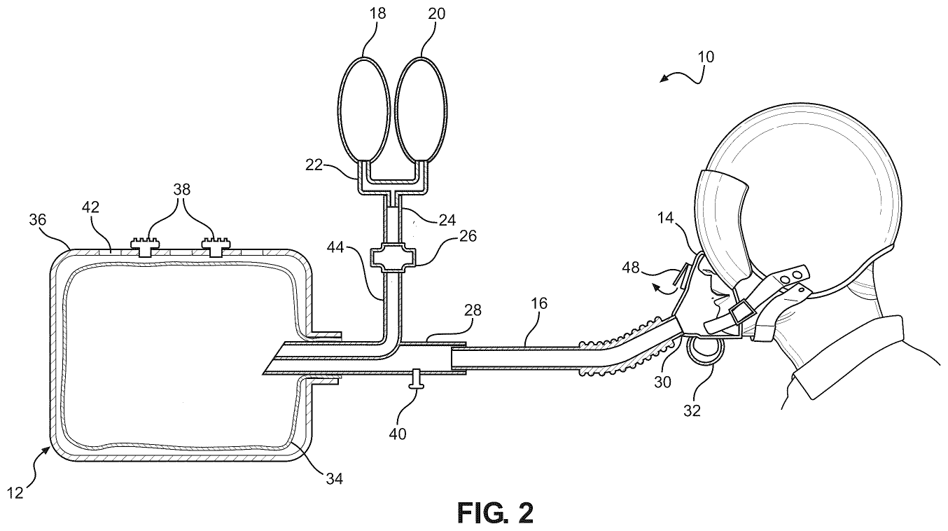

Looking more particularly to the drawings, an embodiment of the system for decreasing hypoxia and asynchronous breathing and for improving the conservation of gases in breathing gas delivery systems disclosed herein is indicated generally at 10 in FIGS. 1 and 2. In FIG. 1, the system 10 is shown during a period of inspiration. In FIG. 2, the system 10 is shown during a period of expiration.

As disclosed herein, the system 10 supplies gases, including oxygen within a mechanical ventilation system, at a predetermined pressure, which may be a pressure elevated in cm/H₂O, to pilots of high-performance combat aircraft, medical patients, and others by use of a flexible, compressible gas reservoir 34. The supply system 10 achieves improved synchrony between the breathing cycle of an individual and the supply provided by the machine formed with the system 10. The system 10 places the individual in greater control of the breathing cycle while the machine formed with the system 10 assumes a more passive role. Rather than asking human beings to adapt to the supply system 10 as has been the case with the prior art, the present invention enables the supply system 10 to adapt to the human. The supply system 10 provides the correct amount of gas and pressure for the requested breath, even where that requested breath is irregular and chaotic as may be the case with an individual under distress requiring mechanical ventilation.

As in FIGS. 1 and 2, embodiments of the supply system 10 interpose the flexible, compressible gas reservoir 34 within a mechanical ventilation system between one or more pressurized gas sources 18 and 20 and an output interface 14 to the individual to provide oxygenation and ventilation. The gas reservoir 34 has an internal volume for retaining breathing gas in adequate volume and at a predetermined pressure for accommodating peak inspiration of an individual. In one non-limiting embodiment, the internal volume of the gas reservoir 34 is 2.5 liters, and the pressure within the gas reservoir 34 is elevated to 4 cm/H₂O. In the depicted example, the mechanical ventilation system comprises a non-invasive ventilation system with a pressurized oxygen gas output and with an output interface 14 comprising a respiration mask 14. However, it will be understood that these are illustrative but non-limiting examples. The inventive concept is applicable to providing oxygenation and ventilation in invasive and non-invasive ventilation systems, with breathing gas blowers, and with high-flow gas regulators with or without system pressurization.

By providing the pressurized gas reservoir 34 according to the present invention, performance improvements are obtained. Dependency on real-time monitoring of variables, such as intentional leaks, tidal volume, and minute ventilation, is reduced. The supply system 10 thus makes the non-invasive ventilation system more responsive to the actual respiratory pattern of the individual with fewer disruptions in the breathing sequence between the individual and the machine of the mechanical ventilation system. The supply system 10 is more reliable in making the gas required available for every breath no matter how chaotic or irregular the individual's breathing may be. As a result, asynchrony and hypoxia and the physiological consequences thereof are expected to be reduced or eliminated. The supply system 10 is designed to increase ventilation and oxygenation while simultaneously reducing the waste of gases, such as oxygen and air.

According to practices of the invention, the flexible, compressible gas reservoir 34 is maintained within the supply system 10 at a desired preset pressure. The gas content of the reservoir 34 is permitted to flow passively in response to the inspiratory and expiratory timing sequence of the individual regardless of how fast or irregular that person's breathing is. The supply system 10 provides the gas, but the individual is in control of the gas to be delivered directly based on the biophysiological request of the individual. In other words, the timing of the breathing cycle and the flow velocity are generated by the individual during spontaneous ventilation, not by the supply system 10. This eliminates many of the limitations and shortcomings exhibited by the prior art. The supply system 10 is less reliant on communication between the individual and the system 10 and potentially complex analysis and processing of that communication. As a consequence, instances of asynchrony are expected to be reduced or eliminated. Also eliminated is the need for the over-compensated high flows required by prior art supply systems to ensure complete and adequate delivery of breathing gas at peak demands, such as those of distressed and exerted individuals during chaotic respirations.

The gas reservoir 34 is capable of retaining adequate gas volume at the approximate pressure requested by an individual such that it is capable of compensating immediately and matching the delivery of the tidal volume (TV) in response to the needs of the individual. The reservoir 34 can respond to variable flow requirements by individuals, such as at a preset level by an operator, and the supply system 10 can deliver the desirable inspiratory peak flow ratio (IPFR) in a synchronized way. This can be accomplished without regard to the inspiratory peak flow ratio, without regard to the size of the tidal volume, and without regard to potentially irregular or chaotic breathing. Instead, the individual becomes the driver of the flow, the respiratory frequency, and the needed tidal volume. However, for avoidance of doubt, it would be possible within the scope of the invention except as expressly excluded by the claims for the supply system 10 to provide support of any necessary or desirable breathing parameter.

Placing the gas reservoir 34 between the individual and the pressurized gas sources 18 and 20 helps dissipate the energy from the high flows prior to reaching the airway of the individual. The gas supplied from the pressurized gas supply sources 18 and 20 is temporarily dispersed into the gas reservoir 34, which is designed to have a volume sufficiently large to accommodate any potential tidal volume that the individual may require. That dispersion reduces the flow pressure. According to practices of the invention, the breathing gas within the gas reservoir 34 can be pressurized to an internal gas pressure above ambient pressure to support breathing, such as between ambient pressure and 20 mbar.

The reservoir 34 complies in providing gas to meet the required tidal volume at inspiratory peak flow demanded by the individual while permitting spontaneous breathing. Under the present invention, the individual no longer depends entirely on a calculated, predetermined tidal volume to be generated by a supply system. Moreover, unlike prior art non-invasive ventilators, there is no longer a direct relation between the gas flow from the gas pressure source and the individual. Instead, as disclosed herein, ample gas supply is retained by the reservoir 34 in excess of tidal volume, and the initial supply relationship is between the gas flow from the pressurized gas source or sources 18 and 20 and the reservoir 34. Needed flow to the individual is provided by the reservoir 34. A replenishing flow to the reservoir 34 from the pressurized supply sources 18 and 20 can be much more simply calculated based simply on how fast the reservoir 34 must be replenished to be ready to provide the required volume inhaled by the individual to reassure access to adequate breathing gas to satisfy the respiratory needs of the individual.

As previously described, prior art non-invasive ventilators have required overcompensated, high-flow nasal cannulas, respiration masks, and helmets seeking to ensure that adequate gas supply is provided. Whether with intermittent or continuous gas flows, intentional leaks are needed in such systems to release the potential excess pressure created by the excessive flow. While such overcompensated, high flows are needed to meet possible higher inspiratory peak flows the individual might exhibit, such as when in respiratory distress, or to keep adequate pressure in the system where intentional leaks are incorporated, they produce massive wastes in compressed breathing gases, such as oxygen and air.

With the use of the reservoir 34 disclosed herein, however, the individual turns from depending on fixed system settings with the hope that they match the actual, variable breathing requirements of the individual to having the actual tidal volume breathing of the individual act as the driver by which input settings can be calculated. While the supply system 10 continuously adapts to the contemporaneous needs of the individual, prior art systems remain fixed until changes are made, such as by an external automatic operator through an input loop or manually by the individual or an operator based on the individual's breathing.

Prior art systems require external input to change or recalculate ventilatory parameters to reply to the individual. Those settings and changes thereto are not always correct in delivering tidal volume to the patient of correct flow, duration, and frequency. Meanwhile, such errors in these variables contribute to hypoxia and asynchronous breathing. Since, under embodiments of the present supply system 10, the individual's own respiratory efforts are in control of the size of the tidal volume supplied through the reservoir 34, the supply system 10 always generates the volume of gas that exactly reflects the inspiratory peak flow of the individual at that individual's own inspiration-to-expiration ratio (I:E) and respiratory rate. The volume, timing, and duration of inspiratory flow are automatically matched by the gas inside the reservoir 34 with the individual breathing spontaneously, breath by breath, regardless of how distressed, variable, or chaotic the respiratory pattern becomes.

The supply system 10 thus provides a more organic, natural way of ventilation and oxygenation. Individuals depend less on machine settings to satisfy their needs for ventilation and oxygenation, and this minimizes or eliminates the risk of breathing asynchrony and hypoxia. The supply system 10 relies on a person's own effort driven by physiologic needs with respect to the amount of air, breathing frequency, and speed of inhalation and exhalation. By providing the gas reservoir 34, the supply system 10 seeks to approximate the natural breathing of ambient air as individuals do continuously every day. In this respect, the air around us may be considered to be just a very large reservoir of air at a certain, namely ambient, pressure. Pressure differences between the lungs and the ambient air reservoir of the atmosphere outside the lungs helps drive the gas into and out of the lungs. The ambient reservoir of the atmosphere reacts passively to the person's efforts and provides gas in volumes and rates dictated entirely by the individual's own effort.

Conversely, with prior art gas support machines and ventilation machines, where no reservoir is provided, the volume requested or at least needed by the lungs of the individual must be met at that instant based on parameters sent to the machine via closed loops and through mathematical algorithms based on approximate calculations designed to cause the machine to dispense the calculated volume at a predetermined speed of flow, pressure, and timing. Such methods are prone to error and individual-ventilator asynchrony, particularly when individuals are breathing irregularly and chaotically during respiratory distress. The overcompensation required to ensure that at least an adequate supply is provided in such systems sacrifices enormous volumes of breathing gases, including oxygen. That has largely become an accepted loss despite the financial consequences and physiological repercussions. Further, gases directly supplied at high pressure and flow are extremely cold and dry. Additional equipment and consumables are required for humidification. Moreover, the pressurized mechanics are noisy. Where such supply systems are unable to match the delivery of breathing gas to demand, which may be particularly exhibited during respiratory distress, the results are dangerous and uncomfortable breathing asynchrony in medical patients and breathing sequence disruption in pilots of combat aircraft.

Referring again to the inspiratory and expiratory diagrams of FIGS. 1 and 2 respectively, the supply system 10 can be seen to interpose the flexible, compressible gas reservoir 34 within a mechanical ventilation system between one or more sources 18 and 20 of pressurized gas, such as oxygen and air, and an output interface 14, such as a respiratory mask, a nasal cannula, or another interface with an individual requiring mechanical ventilation, such as a combat pilot, a medical patient, or another individual. The pressurized source or sources 18 and 20 may provide single gases or gas blends. A regulator of the ventilation system may be operative to permit an adjustment of gas concentration and volume of flow. While first and second pressurized sources 18 and 20 are often shown and described herein, such references are merely illustrative. The system 10 could operate with just one pressurized gas source 18 or 20 or with further pressurized gas sources 18, 20, n.

Flow from the pressurized sources 18 and 20 is delivered to a gas blender 22, which blends the gases supplied by multiple pressurized sources 18 and 20. That blended gas is passed to a conduit 24 that delivers the gas to a valve 26, which may be an electromagnetic solenoid valve with a normally closed condition.

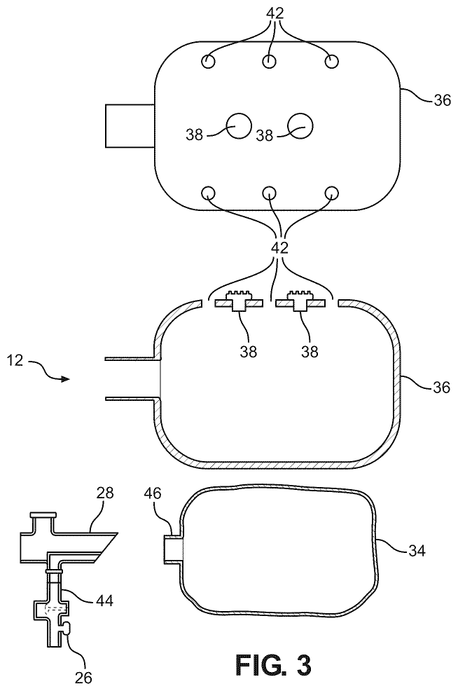

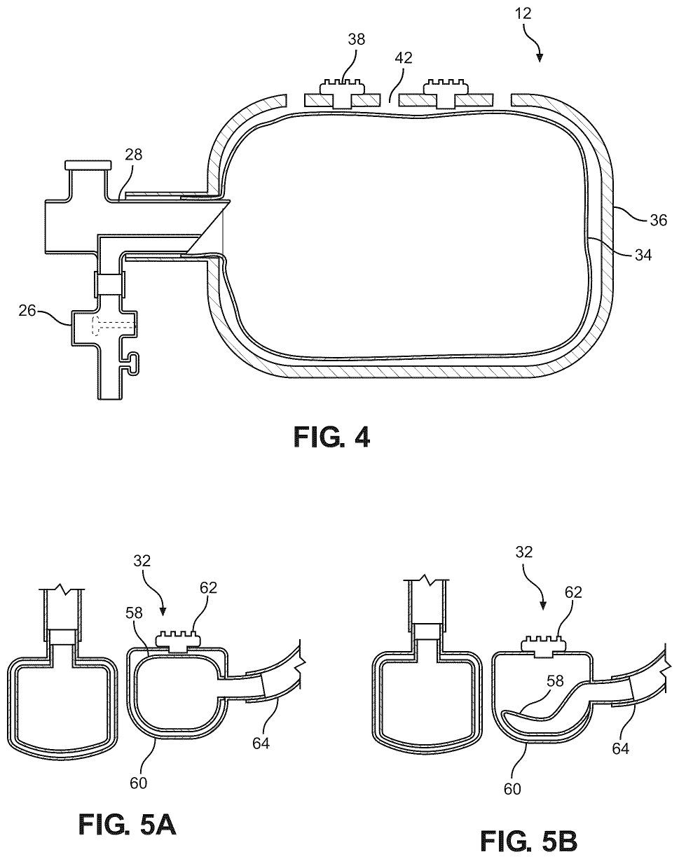

The valve 26 is fluidically coupled to an input port of a multi-port main connector 28, which can be further understood with reference to FIGS. 3 and 4, through a further conduit 44. The multi-port main connector 28 has what may be considered a proximal portion that is sealingly engaged with a neck of the gas reservoir 34. The multi-port main connector 28 has an internal conduit that fluidically connects the input port to the inner volume of the gas reservoir 34. Again, the gas reservoir 34 is sized to have an inflated internal volume, 2.5 liters in one illustrative embodiment, adequate to retain a sufficient volume of breathing gas to accommodate peak inspiration of an individual user. The gas reservoir 34 is flexible and compressible, such as by being formed with an outer wall of flexible, gas impermeable material. In certain embodiments, for instance, the gas reservoir 34 is formed of a polyester or polyethylene film, such as a film of biaxially oriented polyethylene terephthalate (BOPET). Such a polymeric film can be metalized with an aluminum coating or lining and can alternatively be referred to as a polymer foil or polymeric foil where the polymeric film of, for instance, polyethylene terephthalate, is metalized with an aluminum coating or lining. So formed, the gas reservoir 34 is adapted to expand and collapse easily with minimal or no resistance. The material forming the wall or walls of the reservoir 34 has no memory or resilience to expand or collapse by its own force. The reservoir 34 will thus expand and collapse based on the existence of a pressure difference between the inner volume of the reservoir 34 and the remainder of the system 10, including the pilot's or patient's airway. The wall of the reservoir 34 does not have a significant effect on the pressure of the gas contents of the reservoir 34.

The flexible gas reservoir 34 is housed within a rigid reservoir housing 36 such that the reservoir 34 can expand and collapse with negligible resistance within the boundary provided by the housing 36, which prevents further expansion and limits the volume of the reservoir 34.

Together, the gas reservoir 34 and the reservoir housing 36 may be considered to form a reservoir assembly 12, which is shown in an exploded view in FIG. 3 and apart from the remainder of the system 10 in FIG. 4. The gas reservoir 34 and the reservoir housing 36 in this embodiment have generally matching shapes, such as by being substantially box shaped. The multi-port main connector 28, which again is sealingly engaged with the neck of the gas reservoir 34, is fixedly retained by the reservoir housing 36. The connector 28 passes through an aperture within the housing 36 with the proximal portion received therethrough to engage the gas reservoir 34 and a distal portion extending outwardly of the housing 36. The reservoir housing 36 can be calibrated to define a maximum inflated inner volume of the gas reservoir 34. For instance, the inner volume defined by the reservoir housing 36 can substantially match or perhaps somewhat exceed the maximum unrestricted inner volume of the gas reservoir 34. The reservoir housing 36 has plural apertures 42 in one or more walls thereof to permit the free expansion and contraction of the gas reservoir 34. In the depicted embodiment, an array of apertures 42 is disposed in the upper wall of the reservoir housing 36, but the aperture or apertures 42 could be otherwise disposed.

As shown in FIG. 3, the multi-port main connector 28 has a tubular proximal portion that is matingly and sealingly received into a connector sleeve 46 that is affixed in a fluidically sealed manner to the neck of the gas reservoir 34. The tubular proximal portion of the main connector 28 terminates in a mitered end to avoid any plugging of the main connector 28 in relation to the gas reservoir 34. As set forth above, the main connector 28 has a side input port that is in fluidic communication with the pressurized gas sources 18 and 20 through the conduit 44, the solenoid valve 26, and the conduit 24. The side input port of the main connector 28 leads to a channel of the main connector 28 that directs flow toward what may be considered the back of the gas reservoir 34 thereby rapidly dissipating the energy, pressure, and temperature of the high flow gas input received from the pressurized gas sources 18 and 20 into the pressure and temperature of the gas reservoir 34.

The main connector 28 further has a connection port distal to the conduit 44 with respect to the reservoir 34 for fluidic engagement, such as by direct reception or engagement through a conduit, with a pressure sensor 40 operative to detect the pressure of the gas within the reservoir 34. The pressure sensor 40 facilitates a regulation of the internal pressure within the gas reservoir 34, such as by an automatic opening and closing of the solenoid valve 26 based on pressure detected by the sensor 40, to permit or prevent gas to flow into the reservoir 34 from the gas sources 18 and 20. Through mechanical and electronic controls and programming, the supply system 10 exploits the pressure sensor 40 and the solenoid valve 26 to keep the pressure within the gas reservoir 34 at a predetermined pressure or within a predetermined pressure range, which could for example be 0-20 cm/H₂O. Based on the pressure within the gas reservoir 34 as sensed by the pressure sensor 40, the supply system 10 gives electronic commands to the solenoid valve 26 to open and close to permit or prevent the flow of pressurized gas into the reservoir 34 to maintain pressure within the reservoir 34 at the predetermined desired pressure or pressure range.

For pilots of combat aircraft, for instance, the solenoid valve 26, the pressure sensor 40, and the sources 18 and 20 of pressurized breathing gas can cooperate to induce the breathing gas within the gas reservoir 34 to be maintained at a selected, predetermined elevated pressure of approximately 4 cm/H₂O. Where pressure within the gas reservoir 34 is sensed to be below the predetermined pressure, the solenoid valve 26 is opened to supply pressurized gas to the reservoir 34 to raise the pressure until the predetermined pressure is reached as sensed by the pressure sensor 40. When the predetermined pressure is reached as detected by the sensor 40, the supply system 10 adjusts the solenoid valve 26 to a closed condition.

Further and with added reference to FIG. 4, a plurality of distance sensors 38 are disposed to project through apertures 42 in the reservoir housing 36 to have a sensing exposure to the inner volume of the reservoir housing 36 and thus to the facing outer wall of the gas reservoir 34. In this non-limiting embodiment, the distance sensors 38 are disposed to project through apertures 42 in the upper wall of the reservoir housing 36. The distance sensors 38 can be of any effective type, including but not limited to infrared driven, laser, ultrasound, or any other type of distance sensor. The distance sensors 38 can thus sense the distance between the known position of the upper wall of the reservoir housing 36 and the fluctuating position of the facing outer wall of the gas reservoir 34. One or more non-facing outer walls of the reservoir housing 36 can be exploited to retain and restrict one or more surface portions of the outer wall of the gas reservoir 34. For instance, where the distance sensors 38 face toward the upper surface portion of the wall or walls of the gas reservoir 34, the opposite, lower surface portion of the wall or walls of the gas reservoir 34 can be affixed, such as by tape, adhesive, or any other mechanism, to the lower wall of the reservoir housing 36.

The distance between the distance sensors 38 and the facing surface of the wall or walls of the gas reservoir 34 can thus be used to determine the present inflation status of the gas reservoir 34 and thus to calculate the inflation condition and potentially, but not necessarily, the present inner volume defined by the gas reservoir 34 and the volume of breathing gas then retained within the reservoir 34. The calculation of the inner volume of the gas reservoir 34 and thus of the volume of the breathing gas retained therein can be electronically calculated automatically by one or more electronic processors operating computer software according to the invention.

In certain practices, the distance of the surface of the wall of the gas reservoir 34 relative to the distance sensors 38 can be exploited to trigger or permit an opening of the valve 26 and the filling of the gas reservoir 34 by causing the valve 26 to open and thus to cause the filling of the reservoir 34 automatically, such as where the distance sensors 38 detect that the wall of the reservoir 34 is spaced at a predetermined distance from the sensors 38, that the distance between the wall of the reservoir 34 and the sensor is increasing, or based on some other sensed distance characteristic. The valve 26 can be closed and the filling of the reservoir 34 can be automatically ceased based on a different sensed distance characteristic, such as where the outer surface of the wall of the reservoir 34 reaches a given proximity to the sensors 38. The given proximity could be a given spacing or even a condition of touching

Again with reference to FIGS. 1 and 2, an elongate, flexible, non-expandable supply conduit 16 has a first end fluidically coupled to the distal, output port of the main connector 28 and a second end fluidically coupled to the output interface 14 of the supply system 10. Again, any breathing gas output interface 14 could be employed, including a nasal cannula, a respiration mask, a tube, or any other effective output interface 14. Although not directly illustrated in FIGS. 1 and 2, further components and component ports, such as humidification supplies, medication ports, sensor ports, or other components and ports, could be associated with the supply system 10, such as through the supply conduit 16, the output interface 14, or in another location within the system 10.

A one-way inspiratory valve 30 is disposed along the gas supply path between the reservoir 34 and the individual recipient. The valve 30 can, for instance, be disposed between or within the supply conduit 16, the output interface 14, or otherwise. The inspiratory valve 30 permits the breathing gas within the gas reservoir 34 and the supply conduit 16 to be maintained at the desired, predetermined pressure. The inspiratory valve 30 is also operative to prevent rebreathing of exhaled gas. As disclosed herein, the inspiratory valve 30 is calibrated to open mechanically or electro-mechanically during inspiration.

With continued reference to FIGS. 1 and 2 where the output interface 14 comprises a respiration mask, an expiratory valve 48, potentially incorporating a Positive End Expiratory Pressure (PEEP) valve, is fluidically associated with the inner volume of the output interface 14. The expiratory valve 48 is calibrated to open mechanically or electro-mechanically during exhalation. In certain practices, the expiratory valve 48 opens based on a predetermined pressure differential between the pressure within the inner volume between the output interface 14 and the face of the user and the pressure external to the output interface 14. Where the output interface 14 comprises a respiration mask, the inner volume between the output interface 14 and the face of the user may be referred to as a mask inner volume or an output interface inner volume.

In other practices of the invention, the inspiratory valve 30, which selectively permits the passage of breathing gas from the gas reservoir 34 to the user, and the expiratory valve 48, which facilitates the passage of exhaled breath from the output interface 14, and, additionally or alternatively, the solenoid valve 26, which facilitates a refilling of the gas reservoir 34, can be actuated or potentially permitted to actuate between open and closed or closed and open conditions in whole or in part based on inspiration or expiration as sensed by an inspiratory/expiratory sensor switch 32 in fluidic communication with the inner volume defined by the output interface 14 in combination with the face of the user.

Being made aware of the present disclosure, one of skill in the art might appreciate a number of different inspiratory/expiratory sensor switches 32 that could operate according to the invention. However, in the embodiment of FIGS. 1 and 2, the inspiratory/expiratory sensor switch 32 is formed as an electromechanical sensor. As illustrated in FIG. 5, the sensor switch 32, which can be applied to either the inspiratory valve 30 or the expiratory valve 48, is formed with a miniature expandable and compressible sensor reservoir 58 that is disposed within a correspondingly sized and shaped sensor housing 60. The sensor switch 32 incorporates a sensor, which in this example comprises one or more distance sensors 62, operable to detect the inflation condition of the sensor reservoir 58. In the embodiment depicted in FIGS. 1 and 2, where the output interface 14 comprises a respiration mask 14, the sensor housing 60 with the sensor reservoir 58 disposed therewithin is formed to project from the respiration mask 14. The inner volume of the sensor reservoir 58 is in open fluidic communication with the volume between the output interface 14 and the face of the user through an aperture or conduit 64.

Under this construction, when the output interface 14 is disposed on the face of the user, the initiation of inspiration by the wearer will collapse the sensor reservoir 58. That collapse will be sensed by the distance sensor 62 thereby indicating an initiation of a demand for breathing gas. The demand for breathing gas so indicated will trigger an automatic release of the inspiratory valve 30 to permit an opening thereof. For instance, as taught herein, the inspiratory valve 30 can be retained closed at a desired force, such as equivalent to a safety pressure of 4 cm/H₂O, by an electromagnetic field. The electromagnetic field within the inspiratory valve 30 can be reduced or eliminated to reduce or substantially eliminate the pressure differential across the valve 30 required to open the valve 30. With the electromagnetic field discontinued, the inspiratory valve 30 is permitted to open freely without demonstrating resistance to inspiratory effort. Much less pressure than the otherwise required −4 cm/H₂O will thus be required thereby reducing the work of breathing and permitting breathing to occur in a relatively natural manner.

As soon as the wearer begins to expire, the opposite series of events occurs. The initiation of expiration will rapidly fill the sensor reservoir 58, and the filling of the sensor reservoir 58 will be sensed by the distance sensor 62. Upon a sensing of the filling of the sensor reservoir 58, whether fully or simply based on the sensed initiation of filling, the inspiratory valve 30 is automatically actuated to a closed configuration, such as by the initiation of the electromagnetic field where the inspiratory valve 30 is so operated. Positive actuation of the inspiratory valve 30 to a closed condition will cause the valve 30 to close quicker, with more efficiency, and with much lower respiratory effort from the wearer, particularly in comparison to prior art supply systems where an unnatural positive pressure of approximately 4 cm/H₂O has been required to be expended to trigger a closing of an inspiratory valve.

The expiratory valve 48 can be similarly actuated and deactivated, but in an opposite manner. For instance, when the sensor reservoir 58 is detected to be inflated, whether by the distance sensor 62 or otherwise, thereby providing an indication of expiration by the wearer, the expiratory valve 48 can be automatically released to an open condition. Where the expiratory valve 48 is actuated by electromagnetism, for example, the electromagnetic field can be ceased thereby permitting a free opening of the expiratory valve 48 rather than requiring an overcoming of the set pressure, such as 4 cm/H₂O, otherwise required to open the expiratory valve 48. The wearer can then freely exhale faster and more efficiently and naturally. When the sensor reservoir 58 is detected to be deflated or in the process of deflation thereby indicating inhalation, the expiratory valve 48 can be automatically actuated to a closed condition, such as by an initiation of the electromagnetic field thereby again permitting inhalation to occur efficiently and naturally.

The inspiratory/expiratory sensor switch 32 is thus operable as an automatic electrical sensor and switch actuating and deactivating the inspiratory and expiratory valves 30 and 48. By the disclosed operation of the inspiratory/expiratory sensor switch 32, a wearer is able to breathe with a natural rhythm and with relatively natural and unimpeded forces of inspiration and expiration.

It would also be possible and within the scope of practices of the invention to exploit the inspiration or expiration sensed by the inspiratory/expiratory sensor switch 32 to control or impact the filling of the main gas supply reservoir 34. For instance, when the initiation of inspiration by the wearer collapses the sensor reservoir 58 as sensed by the distance sensor 62 to indicate a demand for breathing gas, a filling of the main gas supply reservoir 34 can be triggered, permitted to be triggered, or otherwise affected, such as by an opening of the valve 26 to permit a supply of gas to the gas reservoir 34, by the known demand for breathing gas. Conversely, when the initiation of expiration expands the sensor reservoir 58 as sensed by the distance sensor 62 to indicate expiration, the filling of the main gas supply reservoir 34 can be affected by the known cessation of demand for breathing gas, such as by ceasing, permitting to cease, or otherwise being affected by the known cessation of demand for breathing gas, such as by a closing of the valve 26 to prevent a supply of gas to the gas reservoir 34.

The foregoing operation of the sensor switch 32 is characterized by the inner volume of the sensor reservoir 58 being in open fluidic communication with the volume between the output interface 14 and the face of the user through an aperture or conduit 64. Other embodiments of the sensor switch 32 could be operated in an opposite manner by having the sensor reservoir 58 in open fluidic communication with air exterior to the volume between the output interface 14 and the face of the user. As such, inhalation would tend to expand the sensor reservoir 58 while exhalation would tend to collapse the sensor reservoir 58, and the supply system 10 could control the inspiratory and expiratory valves 30 and 48 based thereon.

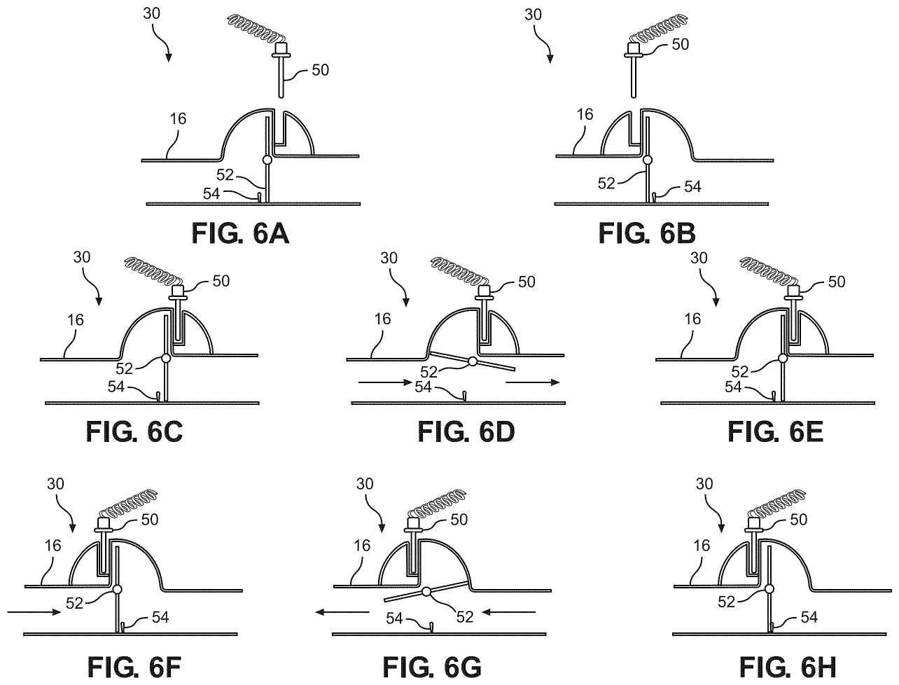

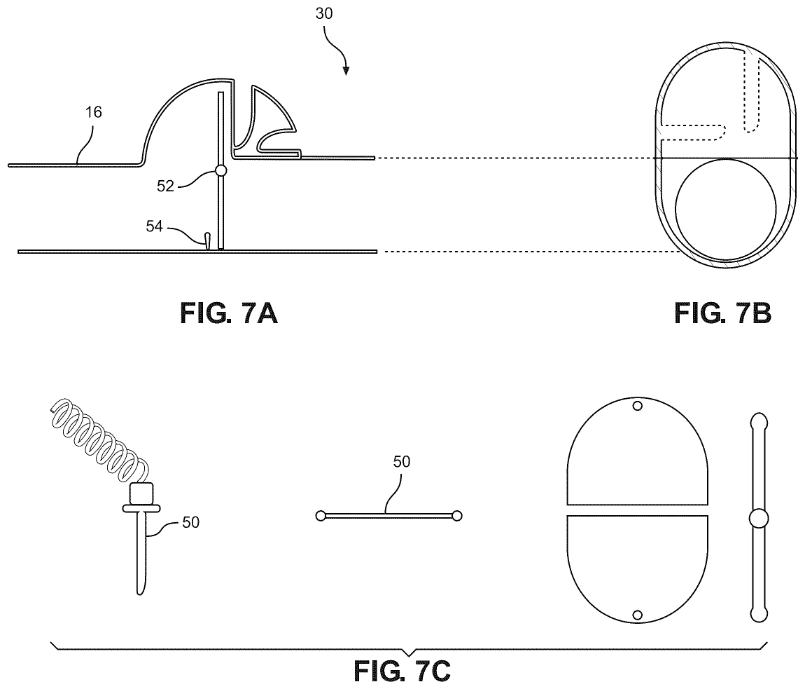

Numerous types of one-way inspiratory and expiratory valves 30 and 48 could be employed within the scope of the invention, including valves 30 and 48 with predetermined opening pressures and with adjustable opening pressures. FIGS. 6 and 7 depict an embodiment of a one-way valve devised pursuant to the present invention. The valve is indicated generally at 30 as for the inspiratory valve 30, but it should be understood that the expiratory valve 48 may be of similar construction.

The one-way valve 30 disclosed herein may be interposed along the conduit 16, disposed between the end of the conduit 16 and the output interface 14, within or fixed to the output interface 14, or otherwise. The valve 30 is formed with a valve leaflet 52 that is pivotable between an open orientation where gas is allowed to flow through the valve 30 and a closed orientation where gas is prevented from flowing through the valve 30. In the embodiment of FIGS. 6A through 6H and 7A through 7C, for instance, the leaflet 52 pivots about a pivot axis at a mid-portion of the leaflet 52. The pivot axis extends laterally across the valve 30 and is approximately aligned with an upper portion of the wall structure defining the passage through the valve 30. With that, a first portion of the leaflet 52 pivots into and out of a position blocking the passage through the valve 30 while a second portion of the leaflet 52 pivots within an arcuate open area of a protuberating or bulb portion that projects distally to the passage through the valve 30.

The leaflet 52 of the present embodiment can be substantially rigid, but it is also within the scope of the invention for the leaflet 52 to be partially or entirely flexible. The leaflet 52 can be crafted from a ferrous material, or ferrous material can be coupled to or incorporated within the leaflet 52. For instance, it is within the scope of the invention for the leaflet 52 to have iron grains retained thereby or embedded therein, or some or all of the body of the leaflet 52 could be formed of a ferrous material. Except as expressly limited by the claims, any leaflet 52 and valve 30 or 48 operable by electromagnetic actuation should be considered to be within the scope of the invention.

An electromagnetic pin 50 is selectively received into a receiving tube in the protuberating portion to draw the second portion of the leaflet 52 into contact therewith when the electromagnetic pin 50 is actuated, and a stopping member 54 is fixed within the valve passage to engage a distal end of the first portion of the leaflet 52 when the leaflet 52 is pivoted to the closed orientation. In the present embodiment, the electromagnetic pin 50 can be selectively inserted into and removed from the protuberating portion of the valve 30 to permit so that the electromagnetic pin 50 can be reused while the body of the valve 30 or the respiratory conduit 16 within which it is disposed can be replaced, such as for use with different users or where the conduit 16 or valve 30 must be replaced for sanitary of other reasons.

When the electromagnetic pin 50 is inserted into the protuberating portion of the valve 30 and actuated with electrical power, it will tend to retain the second portion of the leaflet 52 in contact therewith. As a result, the leaflet 52 will be retained in the closed orientation substantially perpendicular to the valve passage and the flow of gas therethrough with a leaflet closing force. The valve 30 will thus be disposed in a closed condition. The leaflet 52 can be pressed away from the closed orientation by an opening pressure differential across the valve 30. Where the valve 30 is disposed with an opening pivoting where the first portion of the leaflet 52 must pivot fluidically away from the supply provided by the gas reservoir 34 and toward the output interface 14, the leaflet 52 will pivot away from the closed orientation when the pressure differential from the gas reservoir 34 across the valve 30 to the output interface 14 is above a predetermined opening pressure differential, such as by increased pressure from the gas reservoir 34 or reduced pressure from the output interface 14 as with inhalation by the individual. Alternatively, the leaflet 52 will tend to open with a lower opening pressure differential or freely when the electromagnetic force applied within the valve 30 by the electromagnetic pin 50 is reduced or eliminated.

The electromagnetic pin 50 acts as a magnetic pole retained within the body of the valve 30 that can be electro-magnetized at different levels of electromagnetic force. The different levels of electromagnetic force represent proportional predetermined opening pressure differentials. These pressure differentials can be measured in cm/H₂O. The opening pressure differential can thus be selectively adjusted, such as from 0 to 20 cm/H₂O, by an adjustment of the magnetic force applied by the fixed pole of the electromagnetic pin 50 to the opposite magnetic pole, which is located in the second portion of the leaflet 52.

As FIGS. 7A through 7C show, the electromagnetic one-way valve 30 can additionally or alternatively be constructed to permit opposite operation, specifically such that the electromagnetic force of the electromagnetic pin 50 will be operative to maintain the valve 30 in an open condition. In FIGS. 7A through 7C, the valve 30 is constructed similarly to that previously described except that the protuberating portion of the valve 30 has a first receiving tube for receiving the electromagnetic pin 50 in a position where it tends to maintain the valve leaflet 52 in a closed position as previously described and a second receiving tube positioned where it tends to maintain the valve leaflet 52 in an open position. More particularly, the second receiving tube in the depicted embodiment is positioned in parallel to the passage through the valve 30 or otherwise in proximity to the first portion of the valve leaflet 52 when the leaflet 52 is pivoted to an open orientation. When the electromagnetic pin 50 is electrically actuated, the pin 50 will tend to attract and retain the first portion of the valve leaflet 52 in proximity thereto such that the valve leaflet 52 will be in an open condition substantially parallel to the valve passage and the flow of gas through the valve 30.

It is also within the scope of the invention to have a valve 30 with first and second separably actuatable electromagnetic pins 50 with first and second receiving tubes as described above. Under such constructions, the valve leaflet 52 and the valve 30 in general can be selectively maintained or induced to open or closed positions.

Under each construction, actuation and de-actuation of the electromagnetic force within the electromagnetic one-way valve 30 can be performed in multiple different manners. For instance, when the supply system 10 is operational, the electromagnetic force in the one-way valve 30 can be in a consistently or constantly actuated condition such that the valve 30 will tend to exhibit its opening or closing bias and, as applicable, the opening pressure differential consistently or constantly as the system 10 may be electronically programmed. Alternatively, the actuation or de-actuation of the electromagnetic force of the valve 30 and thus the opening pressure differential exhibited thereby could be triggered based on an operational condition of the supply system 10. For instance, where a sensor or other indication determines, such as based on a change in pressure within the output interface 14, that the individual has begun inspiring, a one-way valve 30 positioned along the gas supply path can be automatically de-actuated. Where a sensor or other indication determines, again based on a change in pressure within the output interface 14 or otherwise, that the individual has begun to exhale, the one-way valve 30 positioned along the gas supply path can be automatically actuated. Additionally or alternatively, a one-way valve 48 positioned as an expiratory valve can be automatically de-actuated to permit free opening when exhalation is sensed and can be automatically actuated to a closed position when inhalation is sensed. Again, it is noted that, while the valve has been largely discussed and indicated at 30 as for the inspiratory valve 30, the discussion and depiction herein relates equally to the expiratory valve 48 except as may be expressly excluded.

According to the invention, the supply system 10 can trigger the opening or closing of an inspiratory or expiratory valve 30 or 48 or both so that individuals can breathe in a natural, comfortable, and synchronous way. A closed loop feedback sensor can induce electronic or electro-mechanical opening of the valves 30 and 48 based, for example, on pressure differences, flow characteristics, distance measurements, or other sensed factors.

Again, while the output interface 14 is often shown and described herein as a ventilation mask, other output interfaces 14 are readily possible and within the scope of the invention. Further non-limiting output interfaces 14 could include high-flow nasal cannulas, endotracheal tubes, and laryngeal mask airways. Each could be readily configured to operate pursuant to the present invention.

Particularly where an electromagnetic inspiratory valve 30 is employed, the recipient individual can automatically receive breathing gas at a preset pressure, which may be a positive pressure, when the valve 30 opens with that opening being triggered in part or entirely based on the opening pressure differential being achieved by the individual's own respiratory effort. Again, it is within the scope of the invention for the opening pressure differential to be a predetermined constant, or that opening pressure differential could be varied or eliminated based, for example, on a sensed parameter. For example, the electromagnetic force exhibited by the pin 50 and thus opening pressure differential of the valve 30 could be automatically reduced or eliminated when inspiration is sensed thereby to enable an opening of the valve 30 with a lower respiratory effort. For example, the work of breathing can be reduced when the valve 30 is connected to a closed feedback loop programmed to send a message to the valve 30 when inspiratory effort has just begun to discontinue the application of electromagnetic force within the valve 30. Doing so avoids the individual's needing to continue increasing respiratory effort and the work of breathing to reach the predetermined opening pressure differential of the valve 30 to open the valve 30 and to receive positive inspiratory pressure from the gas reservoir 34.

Under such embodiments, the valve leaflet 52 will open with much lower respiratory effort by the patient, pilot, or other user. Any individual provided with such a supply system 10 with a controllable valve 30 will benefit without a need to expend the respiratory effort required to open a valve according to the prior art with a fixed opening pressure differential. Further, the valve 30 can be closed with lower expiratory effort as inspiration ends and expiration begins. Exploitation of, for example, a closed loop sensing system according to the invention, the electromagnetic field of the inspiratory valve 30 can be actuated at the end of inspiration so that the electromagnetic pole inside the valve 30 attracts the valve leaflet 52 to a closed condition and the electromagnetic pole inside the valve 48 releases the valve leaflet 52 to an open condition. The expiratory flow and the work of breathing needed to open or close the leaflet 52 and thus the valve 30, whether by a medical patient, a pilot, or another individual are thus reduced.

The same concept and benefits readily apply to the electromagnetic expiratory valve 48, which can be similarly constructed. The closed feedback loop reduces or eliminates the opening pressure differential in the expiratory valve 48 on a sensing of the end of inspiration or the beginning of expiration. The expiratory valve 48 thus opens with lower expiratory breathing effort as compared to that required to reach the full required to overcome the predetermined opening pressure differential of the expiratory valve 48. Where, positive end expiratory pressure (PEEP) is required, the electromagnetic force of the expiratory valve 48 can instead be reduced to achieve a predetermined, lowered opening pressure differential rather than a complete cessation of electromagnetic force and opening pressure differential thus again decreasing the needed expiratory effort while providing the needed positive end expiratory pressure.

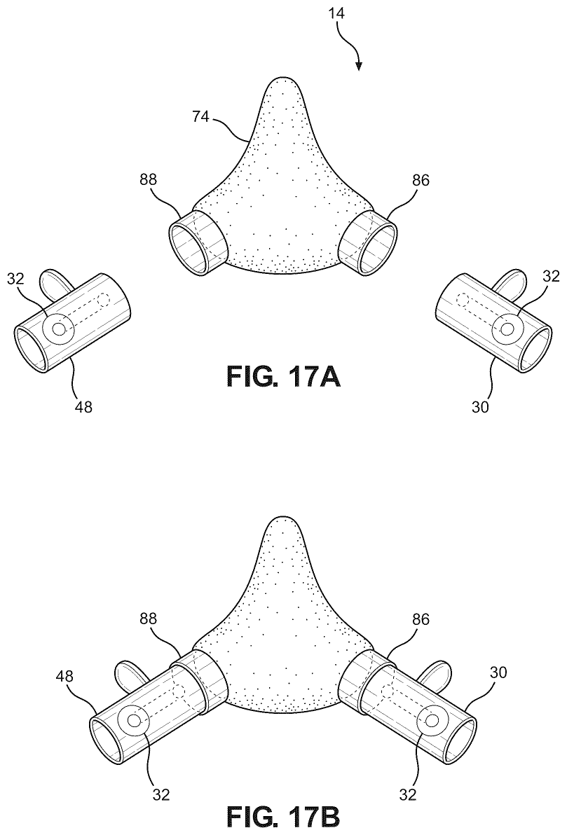

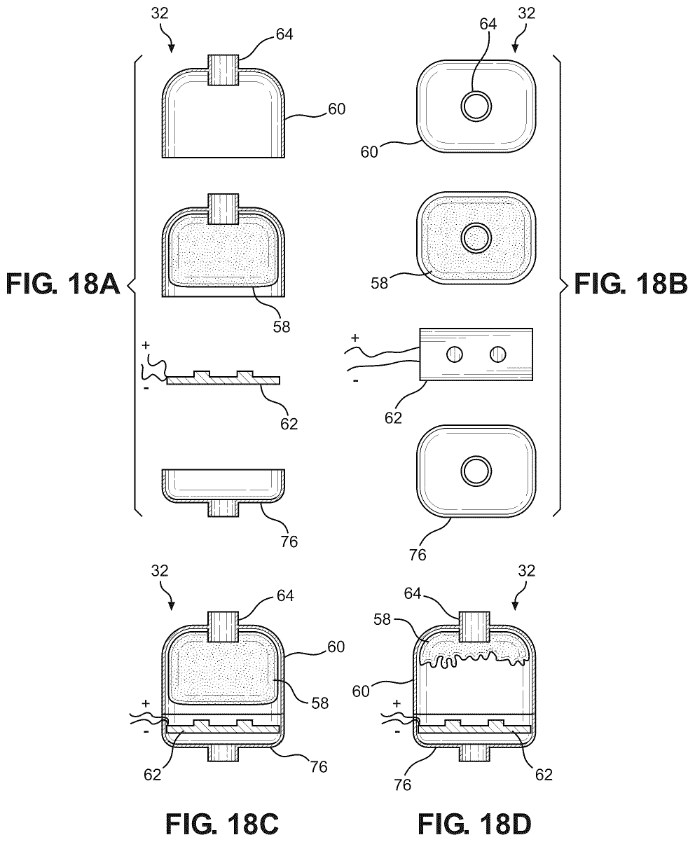

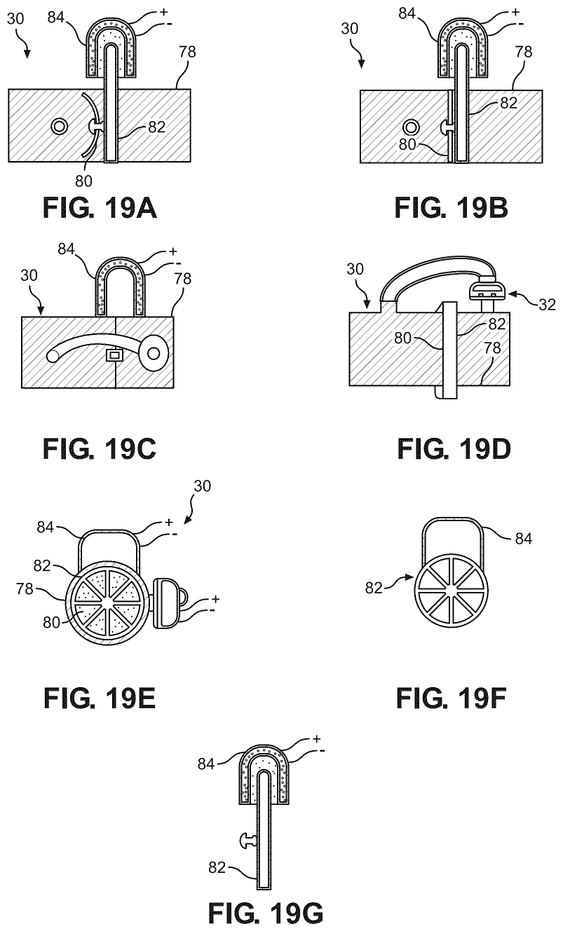

An alternative embodiment of a respiratory mask 14 according to the present invention is depicted in FIGS. 17A and 17B. There, the mask 14 incorporates electromagnetic inspiratory and expiratory valves 30 and 48 actuated by inspiratory/expiratory sensor switches 32. An inspiratory/expiratory sensor switch 32 as employed in the mask 14 of FIGS. 17A and 17B is shown in exploded and assembled views in FIGS. 18A, 18B, and 18C. An alternative embodiment of an inspiratory/expiratory valve is depicted in various states of assembly in FIGS. 19A through 19G where the inspiratory/expiratory valve is indicated generally at 30 as an inspiratory valve 30 with it again being recognized that the expiratory valve 48 can be similarly constructed with an opposite orientation to permit expiration as compared to inspiration.

As shown in FIGS. 17A and 17B, the respiratory mask 14 may be considered to be founded on a mask body 74 that has an inspiration aperture 86 for permitting the inhalation of breathing gas and an expiration aperture 88 for permitting exhalation of breath. The inspiratory and expiratory valves 30 and 48 in the depicted embodiment are formed as removable and replaceable tubular units that are selectively engaged with the inspiration and expiration apertures 86 and 88 respectively. Each of the valves 30 and 48 incorporates a sensor switch 32 according to the invention. The sensor switch 32 of the inspiratory valve 30 is adapted to sense inspiration and to open the inspiratory valve 30 based thereon and to close the inspiratory valve 30 on the cessation thereof, and the sensor switch 32 of the expiratory valve 48 is adapted to sense expiration and to open the expiratory valve 48 based thereon and to close the expiratory valve 48 on the cessation thereof.

As FIGS. 18A through 18D illustrate, each sensor switch 32 relies on an expandable and compressible miniature sensor reservoir 58 that is disposed within a sensor housing 60. A cap 76 closes the sensor housing 60 to encase the sensor reservoir 58. The sensor reservoir 58 is open to the interior of the respective valve 30 or 48 through an aperture, conduit, or other port 64 so that inspiration will tend to collapse the sensor reservoirs 58 and expiration will tend to expand the sensor reservoirs 58. Each sensor switch 32 incorporates a sensor 62 for detecting the inflation condition of the sensor reservoir 58. In the depicted embodiment, the sensor 62 comprises a distance sensor 62, but any other sensor, including but not limited to pressure, distance, contact, and other sensors, operative to detect the inflation condition of the sensor reservoir 58 could be employed.

When the sensor reservoir 58 of the inspiratory valve 30 is inflated thereby indicating the beginning of inspiration, the inspiratory valve 30 is permitted to open by a releasing of the valve 30, and when the sensor reservoir 58 of the inspiratory valve 30 is compressed thereby indicating the beginning of expiration, the inspiratory valve 30 is induced to a closed condition. Conversely, when the sensor reservoir 58 of the expiratory valve 48 is inflated thereby indicating the beginning of inspiration, the expiratory valve 48 is induced to a closed condition, and when the sensor reservoir 58 of the expiratory valve 48 is compressed thereby indicating the beginning of expiration, the expiratory valve 48 is permitted to open by a releasing of the valve 48.

While other valve structures would be possible within the scope of the invention, the inspiratory and expiratory valves 30 and 48 can employ an electromagnetic valve structure as is depicted in relation to the inspiratory valve 30 in FIGS. 19A through 19G with it again being understood that the expiratory valve 48 can be similarly constructed. There, the inspiratory valve 30 is shown to have a tubular valve body 78. An electromagnetic frame 82 has a hub, a central retaining prong retained by the hub, spokes, and an annular ring portion is disposed to span the tubular inner volume of the valve body 78. An annular leaflet 80 is retained by the retaining prong of the electromagnetic frame 82. An electromagnetic coil 84 is connected to the electromagnetic frame 82. The electromagnetic frame 82 produces an electromagnetic field when electrical current is passed through the electromagnetic coil 84. The leaflet 80 retains or is formed from electromagnetic material. In the depicted embodiment, the electromagnetic material comprises iron grains affixed to or embedded within the material of the leaflet 80.

The leaflet 80 of the present embodiment is substantially flexible, but it is also within the scope of the invention for the leaflet 80 to be partially or entirely rigid. The leaflet 80 can be crafted from a ferrous material, or ferrous material can be coupled to or incorporated within the leaflet 80. As shown and described herein, for example, the leaflet 80 can have iron grains retained thereby or embedded therein. Alternatively, the body of the leaflet 80 could be formed of a ferrous material. Except as expressly limited by the claims, any leaflet 80 and valve 30 or 48 operable by electromagnetic actuation should be considered to be within the scope of the invention.

Under the depicted construction, electromagnetic actuation of the electromagnetic frame 82 by the application of electricity will draw the leaflet 80 to a closed condition, such as at a predetermined force resistant to a predetermined pressure differential across the valve 30. When the electromagnetic actuation is ceased, the leaflet 80 will no longer be drawn to the closed condition and will permit the free flow of gas through the valve 30.

With such a valve 30 provided, the pressure within the supply system 10 within and between the gas reservoir 34 and the inspiratory valve 30 can be maintained at a desired, elevated pressure, such as but not limited to 4 cm/H₂O, without a leaking into the respiratory mask 14 when inspiration is not detected. Without regard to the predetermined pressure differential to which the valve 30 is set during electromagnetic actuation, the sensor switch 32 causes the predetermined pressure differential to be ceased during inspiration such that the wearer is not required to overcome the pressure differential through respiratory effort. Breathing is thus more natural and comfortable.

The slight initial negative pressure created by the airway of the user at the initial phase of inspiration will be transmitted through the conduit or other port 64 in fluidic communication with the inspiratory valve 30 to actuate the sensor switch 32 by displacement of the sensor reservoir 58. Where positive pressure is transmitted to the inspiratory valve 30, the sensor reservoir 58 of the inspiratory valve 30 will be inflated. The electrical output to the electromagnetic coil 84 is actuated to electromagnetize the electromagnetic frame 82. The leaflet 80 is attracted by the frame 82 into tight, sealing contact therewith at a force sufficient to keep the system pressure between the valve 30 and the gas reservoir 34 at the predetermined, elevated pressure, such as but not limited to 4 cm/H₂O. Where negative pressure is transmitted, the sensor reservoir 58 of the inspiratory valve 30 will collapse, which is operative to cause a cessation of electrical output to the electromagnetic coil 84 thereby to demagnetize the electromagnetic frame 82. Demagnetization of the electromagnetic frame 82 releases the leaflet 80 thereby permitting the inspiratory valve 30 to open more quickly and with reduced negative inspiratory force and work of breathing by the wearer.

With respect to the expiratory valve 48, positive pressure transmitted to the valve 48 will inflate the sensor reservoir 58. Inflation of the sensor reservoir 58 is operative to cause electrical current to the electromagnetic coil 84 to be ceased thereby demagnetizing the electromagnetic frame 82 and releasing the leaflet 80. The expiratory valve 48 is thus opened quicker and with reduced positive expiratory force and work of breathing from the user. Where negative pressure is transmitted to the expiratory valve 48, the sensor reservoir 58 thereof will deflate thereby causing electrical current to be passed to the electromagnetic coil 84. Electromagnetization of the coil 84 will attract the leaflet 80 tight against the electromagnetic frame 82 thereby preventing breathing gas from being exhausted at a force sufficient to require a set pressure differential across the expiratory valve 48, which again could be 4 cm/H₂O or some other predetermined or otherwise preset pressure differential.

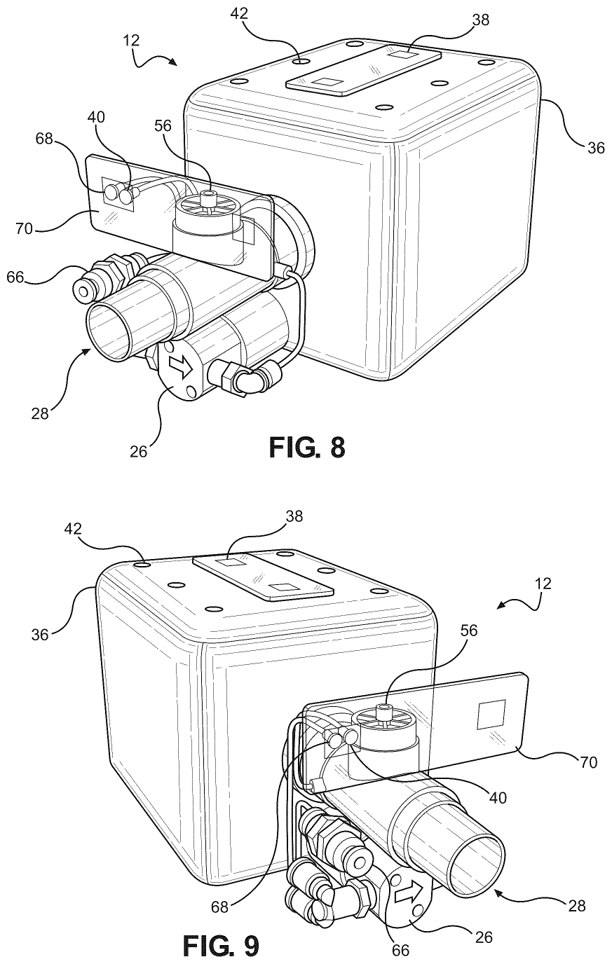

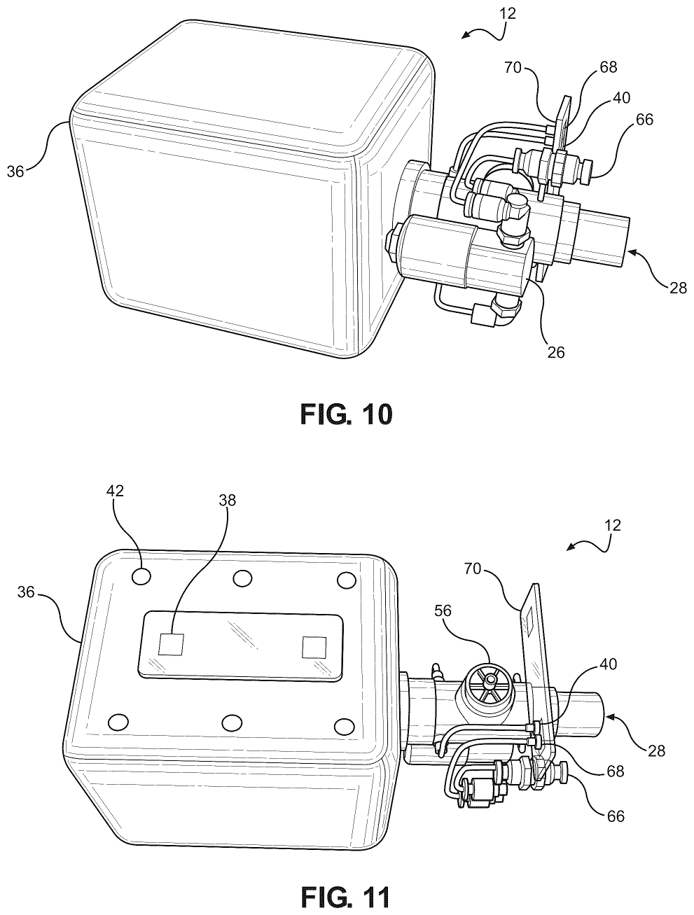

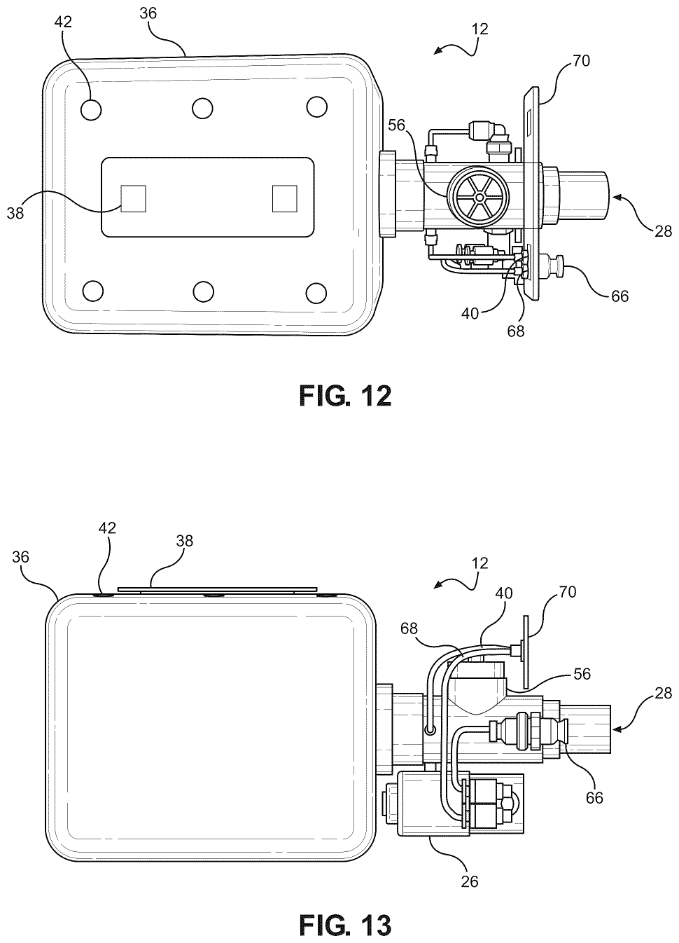

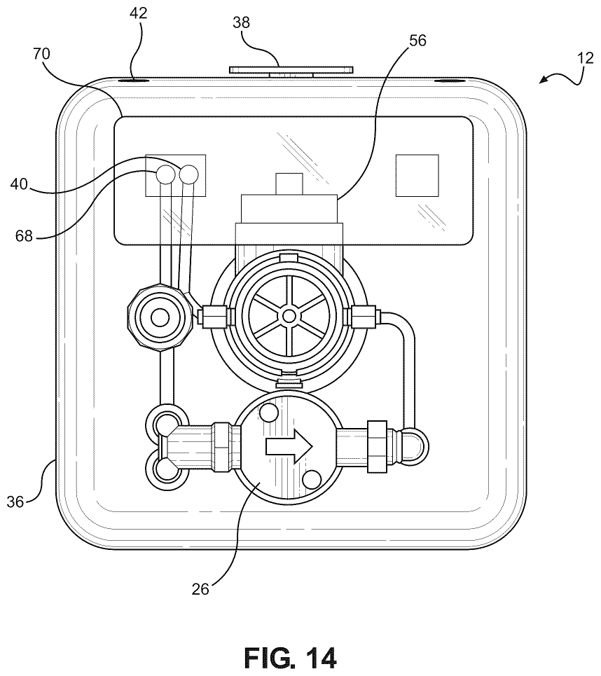

A further embodiment of the reservoir assembly 12 can be understood with reference to FIGS. 8 through 16. There, the reservoir assembly 12 again includes a reservoir housing 36 that encases a gas reservoir 34. A main connector 28 facilitates the gas input and output connections to and from the gas reservoir 34 and provides for pressure and potentially flow sensing. The reservoir housing 36 again retains distance sensors 38, and an array of apertures 42 are disposed therein for permitting unrestricted expansion and contraction of the gas reservoir 34 within the reservoir housing 36.

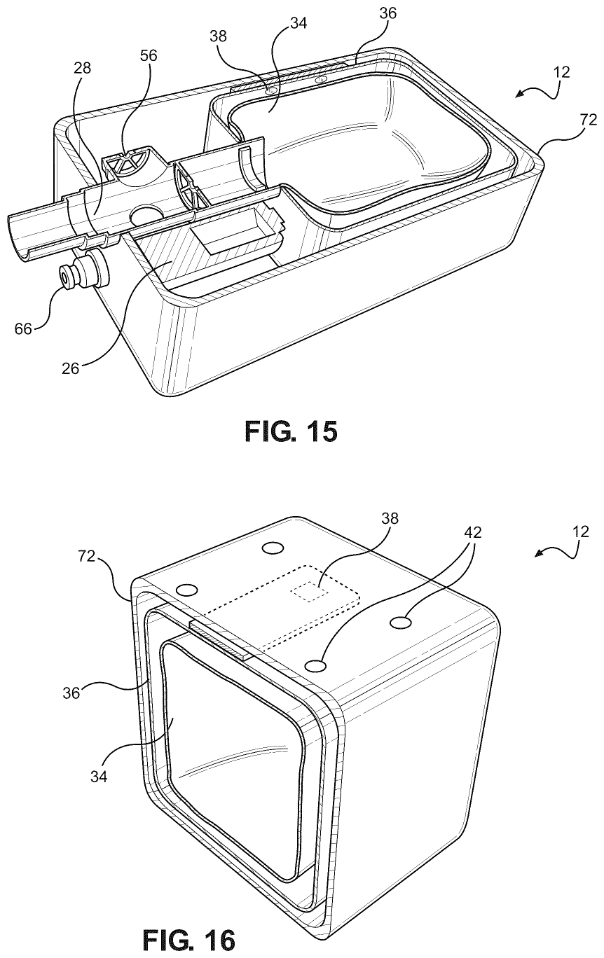

As FIGS. 15 and 16 illustrate, the reservoir assembly 12 can be retained within a casing 72. The main connector 28 has a body portion retained within the casing 72 with a proximal end received into sealed fluidic engagement with the gas reservoir 34 and a distal end for sealed fluidic engagement with, for example, a recipient supply tube 16 as previously shown. In the depicted embodiment, the main connector 28 further includes an ambient air mixing blender 56 that permits a selective and adjustable entrainment of ambient air with the gas supplied from the gas reservoir 34 through the main connector 28.

A panel 70, which may comprise a circuit board panel 70 with computer circuitry, computer memory for retaining dedicated software, and a computer processor for processing the software based, for example, on sensed and input data, is retained, such as within an anterior portion of the casing 72. The panel 70 further retains a pressure sensor 40 in open fluidic communication with the inner volume of the gas reservoir 34 through one or more conduits. The pressure sensor 40 senses the pressure within the reservoir. A connector 66 is provided for connection to a pressurized gas source, and the panel 70 retains a pressure sensor 68 that is in fluidic communication with the connector 66 for sensing the pressure of gas supplied to the reservoir assembly 12 through the connector 66. A solenoid 26 is disposed to permit the selective flow of pressurized gas received through the connector 66 into the inner volume of the gas reservoir 34, such as through a channel or other passage in the main connector 28.

So constructed, the reservoir assembly 12 can be operable largely as described previously. Pressurized gas, such as compressed oxygen or another breathing gas or combination of breathing gases, is received from a source into the connector 66. By actuation of the valve 26, the pressurized breathing gas can be selectively permitted to fill the gas reservoir 34 based on predetermined operating conditions, such as based on a state of inflation of the gas reservoir 34 as sensed by the distance sensors 38, based on a pressure within the gas reservoir 34 as sensed by the pressure sensor 40, based on a sensed inhalation by a user as described herein, or based on some other operating condition or combination thereof. Breathing gas can be drawn from the inner volume of the gas reservoir 34 through a main conduit of the main connector 28. If desired, ambient air can be selectively entrained with breathing gas drawn from the inner volume of the gas reservoir 34 by operation and selective adjustment of the ambient air mixing blender 56.

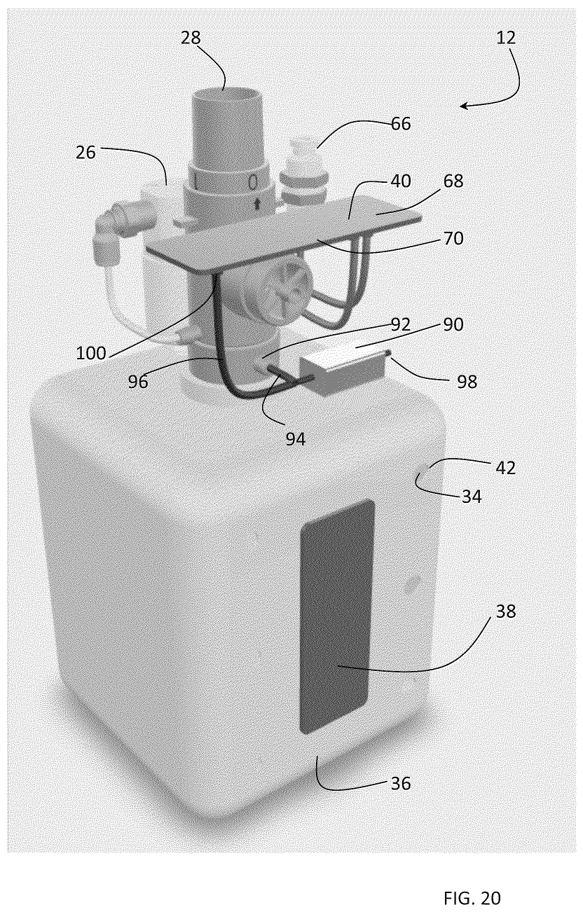

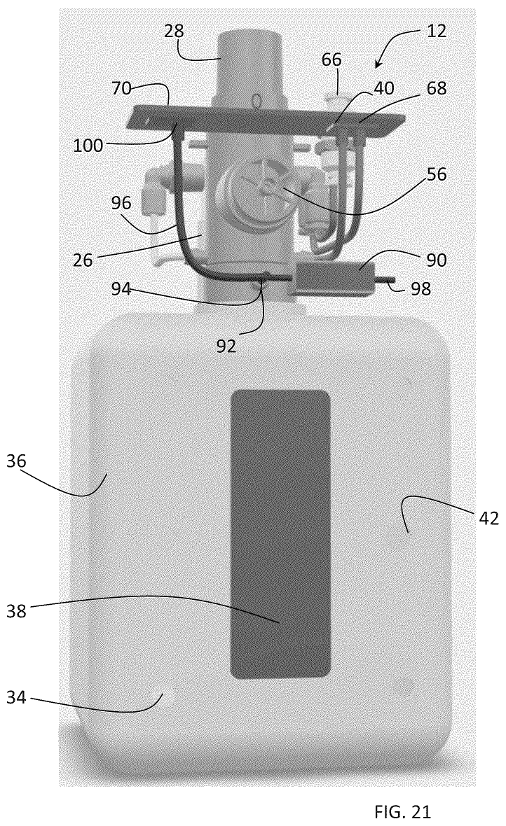

Another embodiment of the reservoir assembly 12 is shown in FIGS. 20 and 21. There, the reservoir assembly 12 again includes a reservoir housing 36. Distance sensors 38 and an array of apertures 42 are disposed in the reservoir housing 36, and the housing 36 again encases a gas reservoir 34, which can be seen through the array of apertures 42 in the housing 36 in FIGS. 20 and 21. A main connector 28 provides gas input and output connections to and from the gas reservoir 34 and provides for pressure and potentially flow sensing in cooperation with circuit board panel 70. The reservoir housing 36 permits unrestricted expansion and contraction of the gas reservoir 34 therewithin.

The main connector 28 has a proximal end received into sealed fluidic engagement with the gas reservoir 34 and a distal end for sealed fluidic engagement with, for example, a recipient supply tube 16 as previously shown. The main connector 28 further includes an ambient air mixing blender 56 that permits a selective and adjustable entrainment of ambient air with the gas supplied from the gas reservoir 34 through the main connector 28.

A circuit board panel 70 with computer circuitry, computer memory for retaining dedicated software, and a computer processor for processing the software based, for example, on sensed and input data, is retained, such as within a casing as previously illustrated. The panel 70 further retains a pressure sensor 40 in open fluidic communication with the inner volume of the gas reservoir 34 through one or more conduits. The pressure sensor 40 senses the pressure within the reservoir 34. A connector 66 is provided for connection to a pressurized gas source, and the panel 70 retains a pressure sensor 68 that is in fluidic communication with the connector 66 for sensing the pressure of gas supplied to the reservoir assembly 12 through the connector 66. A solenoid 26 is disposed to permit the selective flow of pressurized gas received through the connector 66 into the inner volume of the gas reservoir 34, such as through a channel or other passage in the main connector 28.

In the present embodiment, however, a pressure release solenoid 90, which has a normally closed position, is further included to alleviate pressure within the gas reservoir 34 beyond a predetermined maximum pressure. The pressure release solenoid 90 is fluidically open to the pressure within the reservoir 34 through a port 92 and a conduit 94 that connects the pressure release solenoid 90 to the port 92. The solenoid 90 and the inner volume of the reservoir 34 are also fluidically open through a conduit 96 to a pressure sensor 100 retained by the circuit board panel 70. The pressure sensor 100 is thus operable to detect a pressure of the gas contents of the reservoir 34. The pressure release solenoid 90 has an outlet 98 for releasing gas when the pressure release solenoid 90 is open.

Under this construction, a predetermined maximum pressure within the reservoir 34 can be entered into the reservoir assembly 12, such as by being recorded in electronic memory retained by the circuit board panel 70. The predetermined maximum pressure can be fixed or adjustable to suit individual pilots, aircraft, patients, or other particularities. Should the predetermined maximum pressure be reached within the reservoir 34 as detected by the pressure sensor 100, the pressure release solenoid 90 can be automatically triggered to an open condition to permit a release of gas through the outlet 98.

The pressure release solenoid 90 can be programmed in a fixed or adjustable manner through the electronic circuitry, memory, and software of the circuit board panel 70 of the supply system 10 to close upon a detection by the pressure sensor 100 that the contents of the reservoir 34 have reached a predetermined reduced pressure, such as to reach the predetermined maximum pressure or a fixed reduction as compared to the maximum pressure. The pressure release solenoid 90 can be opened until, for instance, a predetermined pressure set by or for the pilot, the aircraft, the patient, or based on some other particularity. A margin of error with respect to the predetermined pressure can be programmed into the system 10.

In one illustrative example, a predetermined maximum pressure for permitting a pilot or patient to be provided with effective and comfortable supply can be set at 10 cm of H₂₀ with a margin of +−1 cm of H₂O. Should the pressure within the reservoir 34 come to exceed the predetermined maximum pressure, such as in the event of a change in altitude or temperature, to reach an excess pressure, such as 12 cm of H₂O, the pressure release solenoid 90 will be automatically opened until the predetermined maximum pressure or the fixed reduction as compared to the maximum pressure is reached whereupon the pressure release solenoid 90 will be automatically brought to a closed condition.

To be complete, it would be possible to program the disclosed supply system 10 to maintain the pressure inside the reservoir 34 not to exceed ambient pressure. In such practices, electronic commands to open and close the pressure release solenoid 90 can be based on distance sensors 38 disposed in visual communication with the reservoir 34, ideally with a portion of the reservoir 34 opposite the sensors 38 being fixed, such as to a wall of the housing 36. For example, the circuit board panel 70 can be programmed to close the supply solenoid valve 26 when the distance between the distance sensor or sensors 38 and the wall of the reservoir 34 reaches a predetermined closing distance, such as 2 centimeters, and to open the supply solenoid valve 26 to permit the flow of replenishing gas into the reservoir 34 when the distance between the sensor or sensors 38 and the wall of the reservoir 34 is detected to exceed that same or some other predetermined opening distance. By way of example, where the reservoir 34 deflates with the pilot's or patient's respiration and a predetermined opening distance between the sensor or sensors 38 and the wall of the reservoir 34, such as 8 cm, is exceeded, the supply solenoid valve 26 can be triggered to an open condition until the predetermined closing distance between the sensor or sensors 38 and the wall of the reservoir is reached whereupon the supply solenoid valve 26 will be automatically triggered to a closed condition.

The disclosure of application Ser. No. 17/068,718, filed Oct. 12, 2020 and entitled Automatic System for the Conservation of Gas and Other Substances, may be considered relevant to the present invention. That application is incorporated herein by reference in its entirety.

With certain details and embodiments of the present invention for a system and method for decreasing hypoxia and asynchronous breathing and for improving the conservation of gases in breathing gas delivery systems disclosed, it will be appreciated by one skilled in the art that numerous changes and additions could be made thereto without deviating from the spirit or scope of the present invention. This is particularly true when one bears in mind that the presented preferred embodiments merely exemplify the broader invention revealed herein. Accordingly, it will be clear that those with major features in mind could craft embodiments that incorporate those major features while not incorporating all of the features included in the preferred embodiments.

Therefore, the following patent claims shall define the scope of protection to be afforded to the invention. Those claims shall be deemed to include equivalent constructions insofar as they do not depart from the spirit and scope of the invention. It must be further noted that a plurality of the following claims may express, or be interpreted to express, certain elements as means for performing a specific function, at times without the recital of structure or material. As the law demands, any such claims shall be construed to cover not only the corresponding structure and material expressly described in this specification but also all legally-cognizable equivalents thereof.

What is claimed as deserving of Letters Patent is:

1. A supply system for decreasing hypoxia and asynchronous breathing and for improving the conservation of breathing gases in breathing gas delivery through a mechanical ventilation system, the supply system comprising:
an expandable and compressible gas reservoir, the gas reservoir with an outer wall and an inner volume for retaining a volume of breathing gas;
a fluidic connector sealingly engaged with the gas reservoir;
an input valve in fluidic communication with the gas reservoir through the fluidic connector, the input valve disposed fluidically upstream of the gas reservoir for receiving pressurized breathing gas from one or more pressurized gas sources and for selectively permitting breathing gas to flow to and fill the gas reservoir through the fluidic connector;
wherein the fluidic connector is operative to deliver breathing gas received from the input valve into the inner volume of the gas reservoir and wherein the fluidic connector is operative to deliver gas out of the inner volume of the gas reservoir;
an output interface for outputting breathing gas to a face of a user;
a supply conduit fluidically interposed between the gas reservoir and the output interface;
an inspiratory sensor in fluidic communication with the output interface wherein the inspiratory sensor is operative to sense inspiration through the output interface;
an expiratory sensor in fluidic communication with the output interface wherein the expiratory sensor is operative to sense expiration through the output interface;
an inspiratory valve fluidically interposed between an inner volume of the output interface and the gas reservoir;
an expiratory valve in fluidic communication with the output interface;
wherein the supply system is operative to permit an opening of the inspiratory valve when inspiration is sensed by the inspiratory sensor and wherein the supply system is operative to permit an opening of the expiratory valve when expiration is sensed by the expiratory sensor.

2. The supply system of claim 1, wherein the gas reservoir is housed within a rigid reservoir housing.

3. The supply system of claim 2, further comprising a distance sensor retained by the housing wherein the distance sensor is operative to sense a distance of the outer wall of the gas reservoir from the distance sensor, wherein the input valve is operative to open and close to permit or prevent flow of breathing gas to the reservoir based on the distance of the outer wall of the gas reservoir from the distance sensor as sensed by the distance sensor.

4. The supply system of claim 1, wherein the output interface comprises a respiration mask and wherein a mask inner volume is established between the respiration mask and the face of the user.

5. The supply system of claim 4, wherein the expiratory valve is retained by the respiration mask.

6. The supply system of claim 1, wherein the inspiratory sensor comprises a sensor reservoir positioned to be fluidically open to an output interface inner volume between the output interface and the face of the user, wherein the inspiratory sensor is operative to detect a state of inflation of the sensor reservoir, wherein a predetermined pressure differential between the output interface inner volume and a volume exterior to the output interface will expand or compress the sensor reservoir to indicate that the user is inhaling, wherein the sensor reservoir will compress or expand when the user ceases inhaling and begins exhaling, and wherein the supply system is operative to close or permit an opening of the inspiratory valve based on the state of inflation of the sensor reservoir.

7. The supply system of claim 1, wherein the expiratory sensor comprises a sensor reservoir positioned to be fluidically open to an output interface inner volume between the output interface and the face of the user, wherein the expiratory sensor is operative to detect a state of inflation of the sensor reservoir, wherein a predetermined pressure differential between the output interface inner volume and a volume exterior to the output interface will expand or compress the sensor reservoir to indicate that the user is inhaling, wherein the sensor reservoir will compress or expand when the user ceases inhaling and begins exhaling, and wherein the supply system is operative to close or permit an opening of the expiratory valve based on the state of inflation of the sensor reservoir.

8. The supply system of claim 1, wherein an inspiratory-expiratory sensor is operative as the inspiratory sensor and the expiratory sensor.

9. The supply system of claim 8, wherein the inspiratory-expiratory sensor comprises a sensor reservoir positioned to be fluidically open to an output interface inner volume between the output interface and the face of the user, wherein the inspiratory-expiratory sensor is operative to detect a state of inflation of the sensor reservoir, wherein a predetermined pressure differential between the output interface inner volume and a volume exterior to the output interface will expand or compress the sensor reservoir to indicate that the user is inhaling, wherein the sensor reservoir will compress or expand when the user ceases inhaling and begins exhaling, and wherein the supply system is operative to close or permit an opening of the inspiratory valve and the expiratory valve based on the state of inflation of the sensor reservoir.

10. The supply system of claim 1, wherein the inspiratory valve comprises an electromagnetic valve with an open condition and a closed condition wherein the inspiratory valve is actuated to a closed condition when expiration is sensed by the expiratory sensor and wherein the inspiratory valve is released from the closed condition when inspiration is sensed by the inspiratory sensor.

11. The supply system of claim 10, wherein the inspiratory valve has a valve leaflet with an open condition and a closed condition and an electromagnetic member operative when actuated to tend to retain the valve leaflet in either the open condition or the closed condition.

12. The supply system of claim 1, wherein the expiratory valve comprises an electromagnetic valve with an open condition and a closed condition wherein the expiratory valve is actuated to a closed condition when inspiration is sensed by the inspiratory sensor and wherein the expiratory valve is released from the closed condition when expiration is sensed by the expiratory sensor.

13. The supply system of claim 12, wherein the expiratory valve has a valve leaflet with an open condition and a closed condition and an electromagnetic member operative when actuated to tend to retain the valve leaflet in either the open condition or the closed condition.

14. The supply system of claim 1, further comprising a pressure sensor operative to detect a pressure of the breathing gas within the inner volume of the reservoir, wherein the input valve and the pressure sensor cooperate to maintain breathing gas within the gas reservoir at an elevated pressure above ambient pressure.

15. The supply system of claim 14, wherein the input valve and the pressure sensor cooperate to maintain breathing gas within the gas reservoir at an elevated pressure above ambient pressure of approximately 4 cm/H₂O.

16. The supply system of claim 14, wherein the supply system comprises a breathing gas supply system of a combat aircraft.

17. The supply system of claim 16, wherein the gas reservoir has an inner volume of approximately 2.5 liters.

18. The supply system of claim 16, wherein the output interface comprises a combat aircraft respiratory mask.

19. The supply system of claim 1, wherein the outer wall of the gas reservoir is formed from a polymeric film.

20. The supply system of claim 19, wherein the polymeric film comprises a film of biaxially oriented polyethylene terephthalate (BOPET).

21. The supply system of claim 1, wherein the fluidic connector comprises a multi-port fluidic connector with an input port for receiving breathing gas and an output port for supplying breathing gas to the output interface.

22. The supply system of claim 21, wherein the fluidic connector further has a connection port and further comprising a pressure sensor fluidically connected to the connection port, wherein the pressure sensor is operative to detect a pressure of breathing gas within the inner volume of the reservoir.

23. The supply system of claim 1, wherein at least one of a sensing of inspiration by the inspiratory sensor and a sensing of expiration by the expiratory sensor is operative to trigger an opening or a closing of the input valve.

24. The supply system of claim 1, wherein the inspiratory valve comprises an electromagnetic valve with an open condition and a closed condition, wherein the inspiratory valve is actuated to the closed condition when expiration is sensed by the expiratory sensor, wherein the inspiratory valve is released from the closed condition when inspiration is sensed by the inspiratory sensor, wherein the inspiratory valve has a valve leaflet that is pivotable between an open orientation where gas is allowed to flow through the valve and a closed orientation where gas is prevented from flowing through the valve, wherein the valve leaflet is selectively maintained in the closed condition by electromagnetic force when expiration is sensed by the inspiratory sensor.

25. The supply system of claim 1, wherein the expiratory valve comprises an electromagnetic valve with an open condition and a closed condition, wherein the expiratory valve is actuated to the closed condition when inspiration is sensed by the inspiratory sensor, wherein the expiratory valve is released from the closed condition when expiration is sensed by the expiratory sensor, wherein the expiratory valve has a valve leaflet that is pivotable between an open orientation where gas is allowed to flow through the valve and a closed orientation where gas is prevented from flowing through the valve, wherein the valve leaflet is selectively maintained in the closed condition by electromagnetic force when inspiration is sensed by the inspiratory sensor.

26. In a combat aircraft, a combat aircraft oxygen supply system for decreasing hypoxia and asynchronous breathing and for improving the conservation of oxygen in oxygen delivery through an aircraft mechanical ventilation system, the combat aircraft supply system comprising:
an expandable and compressible oxygen reservoir, the oxygen reservoir with an outer wall and an inner volume for retaining a volume of oxygen;
an input valve in fluidic communication with the oxygen reservoir, the input valve disposed fluidically upstream of the oxygen reservoir for receiving pressurized oxygen from one or more pressurized oxygen sources and for selectively permitting oxygen to flow to and fill the oxygen reservoir;
an oxygen mask for outputting oxygen to a combat aircraft pilot wearing the oxygen mask wherein a mask inner volume is established between the oxygen mask and the face of the combat aircraft pilot;
a supply conduit fluidically interposed between the gas reservoir and the oxygen mask;
an inspiratory sensor in fluidic communication with the oxygen mask wherein the inspiratory sensor is operative to sense inspiration through the oxygen mask;
an expiratory sensor in fluidic communication with the oxygen mask wherein the expiratory sensor is operative to sense expiration through the oxygen mask;
an inspiratory valve fluidically interposed between the mask inner volume and the gas reservoir;
an expiratory valve in fluidic communication with the oxygen mask;
wherein the combat aircraft supply system is operative to permit an opening of the inspiratory valve when inspiration is sensed by the inspiratory sensor and wherein the combat aircraft supply system is operative to permit an opening of the expiratory valve when expiration is sensed by the expiratory sensor.

27. The combat aircraft supply system of claim 26, wherein the oxygen reservoir is housed within a rigid reservoir housing and further comprising a distance sensor retained by the housing wherein the distance sensor is operative to sense a distance of the outer wall of the oxygen reservoir from the distance sensor, wherein the input valve is operative to open and close to permit or prevent flow of oxygen to the oxygen reservoir based on the distance of the outer wall of the oxygen reservoir from the distance sensor as sensed by the distance sensor.

28. The combat aircraft supply system of claim 26, wherein the inspiratory sensor comprises a sensor reservoir positioned to be fluidically open to the mask inner volume, wherein the inspiratory sensor is operative to detect a state of inflation of the sensor reservoir, wherein a predetermined pressure differential between the mask inner volume and a volume exterior to the output interface will expand or compress the sensor reservoir to indicate that the combat aircraft pilot is inhaling, wherein the sensor reservoir will compress or expand when the combat aircraft pilot ceases inhaling and begins exhaling, and wherein the combat aircraft supply system is operative to close or permit an opening of the inspiratory valve based on the state of inflation of the sensor reservoir.

29. The combat aircraft supply system of claim 1, wherein the expiratory sensor comprises a sensor reservoir positioned to be fluidically open to the mask inner volume, wherein the expiratory sensor is operative to detect a state of inflation of the sensor reservoir, wherein a predetermined pressure differential between the mask inner volume and a volume exterior to the oxygen mask will expand or compress the sensor reservoir to indicate that the combat aircraft pilot is inhaling, wherein the sensor reservoir will compress or expand when the combat aircraft pilot ceases inhaling and begins exhaling, and wherein the supply system is operative to close or permit an opening of the expiratory valve based on the state of inflation of the sensor reservoir.

30. The combat aircraft supply system of claim 1, wherein an inspiratory-expiratory sensor is operative as the inspiratory sensor and the expiratory sensor.

31. The combat aircraft supply system of claim 30, wherein the inspiratory-expiratory sensor comprises a sensor reservoir positioned to be fluidically open to the mask inner volume, wherein the inspiratory-expiratory sensor is operative to detect a state of inflation of the sensor reservoir, wherein a predetermined pressure differential between the output interface inner volume and a volume exterior to the output interface will expand or compress the sensor reservoir to indicate that the combat aircraft pilot is inhaling, wherein the sensor reservoir will compress or expand when the combat aircraft pilot ceases inhaling and begins exhaling, and wherein the supply system is operative to close or permit an opening of the inspiratory valve and the expiratory valve based on the state of inflation of the sensor reservoir.

32. The combat aircraft supply system of claim 26, wherein the inspiratory valve comprises an electromagnetic valve with an open condition and a closed condition wherein the inspiratory valve is actuated to a closed condition when expiration is sensed by the expiratory sensor and wherein the inspiratory valve is released from the closed condition when inspiration is sensed by the inspiratory sensor.

33. The combat aircraft supply system of claim 1, further comprising a pressure sensor operative to detect a pressure of the oxygen within the inner volume of the oxygen reservoir, wherein the input valve and the pressure sensor cooperate to maintain oxygen within the oxygen reservoir at an elevated pressure above ambient pressure.

34. The combat aircraft supply system of claim 33, wherein the input valve and the pressure sensor cooperate to maintain oxygen within the oxygen reservoir at an elevated pressure above ambient pressure of approximately 4 cm/H₂O.

35. The combat aircraft supply system of claim 26, wherein the outer wall of the oxygen reservoir is formed from a polymeric film.

36. The combat aircraft supply system of claim 26, wherein the inspiratory valve comprises an electromagnetic valve with an open condition and a closed condition, wherein the inspiratory valve is actuated to the closed condition when expiration is sensed by the expiratory sensor, wherein the inspiratory valve is released from the closed condition when inspiration is sensed by the inspiratory sensor, wherein the inspiratory valve has a valve leaflet that is pivotable between an open orientation where gas is allowed to flow through the valve and a closed orientation where gas is prevented from flowing through the valve, wherein the valve leaflet is selectively maintained in the closed condition by electromagnetic force when expiration is senses by the inspiratory sensor.

37. The combat aircraft supply system of claim 26, wherein the expiratory valve comprises an electromagnetic valve with an open condition and a closed condition, wherein the expiratory valve is actuated to the closed condition when inspiration is sensed by the inspiratory sensor, wherein the expiratory valve is released from the closed condition when expiration is sensed by the expiratory sensor, wherein the expiratory valve has a valve leaflet that is pivotable between an open orientation where gas is allowed to flow through the valve and a closed orientation where gas is prevented from flowing through the valve, wherein the valve leaflet is selectively maintained in the closed condition by electromagnetic force when inspiration is sensed by the inspiratory sensor.
